(19) United States
(12) Patent Application Publication
(10) Pub. No.: US 2025/0034415 A1
(43) Pub. Date: Jan. 30, 2025

(54) ACTIVE ENERGY RAY CURABLE INKJET INK, METHOD FOR PRODUCING INKJET INK, INKJET RECORDING METHOD, AND INKJET RECORDING SYSTEM

(71) Applicant: Konica Minolta, Inc., Tokyo (JP)

(72) Inventor: Masami OBARA, Sagamihara-shi (JP)

(21) Appl. No.: 18/777,115

(22) Filed: Jul. 18, 2024

(30) Foreign Application Priority Data
Jul. 28, 2023 (JP) 2023-122941

(51) Int. Cl. C09D 11/326; B41M 7/00; C09D 11/037; C09D 11/101; C09D 11/107; C09D 11/322

(52) U.S. Cl. CPC C09D 11/326; C09D 11/037; C09D 11/101; C09D 11/107; C09D 11/322; B41M 7/0081

(57) ABSTRACT

An active energy ray curable inkjet ink includes, a pigment, a dispersant, a gelling agent, and an additive. A compound having a structure derived from a hydroxy fatty acid and a basic functional group is contained as the dispersant. A compound having a pyridine structure is contained as the additive.

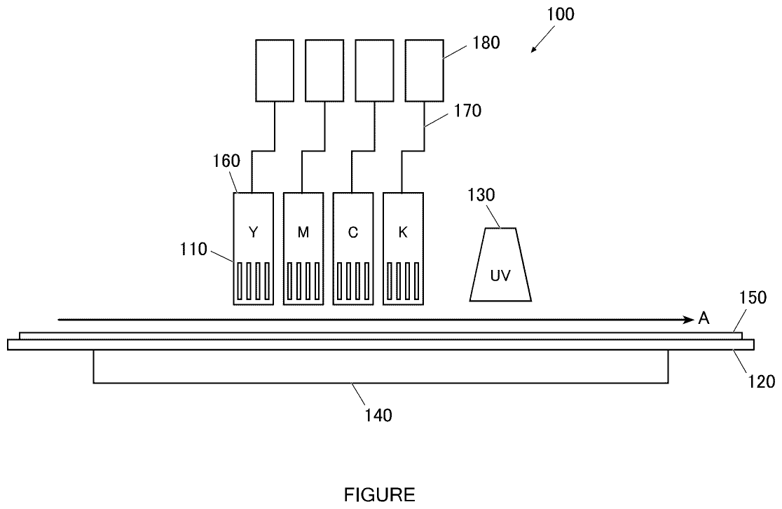

### CROSS-REFERENCE TO RELATED APPLICATIONS

The entire disclosure of Japanese Patent Application No. 2023-122941, filed on Jul. 28, 2023, including description, claims, drawings and abstract is incorporated herein by reference.

### BACKGROUND OF THE INVENTION

### Technical Field

The present invention relates to an active energy ray curable inkjet ink, a method for producing the same, an inkjet recording method, and an inkjet recording system. More specifically, the present invention relates to an active energy ray curable inkjet ink and the like in which glossiness is improved in an image to be formed.

### Description of Related Art

Inkjet recording methods are used in various printing fields because images can be formed easily and inexpensively. As a type of ink used in the inkjet recording method, an active energy ray curable ink is exemplified. With an active energy ray curable ink, ink droplets are landed on a recording medium and then cured by irradiation with active energy rays to form an image. To form an image even on a recording medium having no ink absorbency is possible by an inkjet recording method using an active energy ray curable ink. In addition, an image to be formed has high scratch resistance and adhesiveness, and thus has attracted attention in recent years.

In the inkjet recording method, since it is necessary to eject liquid droplets of the ink from a nozzle of an inkjet head, ejection stability is required for the ink. In addition, when an ink droplet landed on a recording medium is mixed with an adjacent droplet, the formed dots merge with each other, and a white out occurs. In addition, in a case of using color ink, a problem such as mixing of colors occurs. Therefore, it is necessary to fix the ink after the droplets of the ink have landed on the recording medium. In particular, in the case of high-speed recording, it is necessary to fix the ink immediately after the ink droplets are landed on the recording medium.

However, in the ink which is quickly fixed on the recording medium, the pigment is easily aggregated in the fixing process. Therefore, further improvement in the glossiness of the image to be formed is required.

Japanese Unexamined Patent Publication No. 2013-213196 discloses a technique for a radiation curable inkjet ink set containing specific pigments in a range of 1.5 to 2.5% by mass. It is also described that the ink set may further contain a polymer dispersant, and a technique relating to an applicable polymer dispersant is disclosed. However, even when the above-described technology is used, it cannot be said that the obtained gloss is sufficient in the formed image.

Sol-gel phase transition ink is known as ink that quickly solidifies on a recording medium. The sol-gel phase transition ink is solated or gelled by temperature, and the viscosity changes. For example, at the time of ink ejection, the ink is solated under a relatively high temperature environment. Thus, the ink viscosity decreases, and satisfactory ink ejection stability is obtained. In addition, gelation occurs under a relatively low-temperature environment at the time of ink landing. Thus, the viscosity of the ink increases, and the ink tends to be fixed. However, since the viscosity of the sol-gel phase transition ink rapidly increases at the time of landing, the pigment is more likely to aggregate.

In Japanese Unexamined Patent Publication No. 2015-52082, a technology for an active ray curable inkjet ink containing a photopolymerizable compound, a photopolymerization initiator, a gelling agent, a colorant, and a polymer dispersant is disclosed. In Japanese Unexamined Patent Publication No. 2015-52082, a technology for polymer dispersants having an amine group is disclosed. Note that the amine group here functions as a functional group adsorptive to water-insoluble organic pigment. Although an image having glossiness to some extent can be formed by using the above-described technology, further improvement in glossiness is required.

### SUMMARY OF THE INVENTION

The present invention has been made in consideration of the above-mentioned problems and situations. The problem to be solved is to provide an active energy ray curable inkjet ink that forms an image having improved gloss, a method for producing the same, an inkjet recording method, and an inkjet recording system.

To achieve the object, the present inventors have studied the causes of the above problems and the like. The active energy ray curable inkjet ink containing a pigment, a dispersant, a gelling agent and an additive contains, as the dispersant, a compound having a structure derived from a hydroxy fatty acid and a basic functional group. The ink contains a compound having a pyridine structure as an additive. Thus, the present inventors have found that the glossiness of the image formed using the ink is improved, and have completed the present invention.

That is, the above-described problems according to the present invention are solved by the following means.

According to one aspect, the active energy ray curable inkjet ink includes, a pigment, a dispersant, a gelling agent, and an additive, wherein, a compound having a structure derived from a hydroxy fatty acid and a basic functional group is contained as the dispersant, and a compound having a pyridine structure is contained as the additive.

According to another aspect, the method for producing an active energy ray curable inkjet ink, to produce the active energy ray curable inkjet ink according to the above includes, preparing a pigment dispersion liquid containing the pigment and the dispersant; and preparing the active energy ray curable inkjet ink containing the pigment dispersion liquid, the gelling agent, and the additive.

According to another aspect, the inkjet recording method for recording by causing ejected ink to land on a recording medium, the method including: recording using the active energy ray curable inkjet ink according to the above, wherein an ejection temperature of the ink is within a range of 40 to 120° C., and a temperature of the recording medium is 60° C. or lower.

According to another aspect, the inkjet recording system that performs recording by causing ejected ink to land on a recording medium, the inkjet recording system including, the active energy ray curable inkjet ink according to the above.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIGURE is a schematic diagram illustrating an exemplary configuration of an image forming apparatus 100.

### DETAILED DESCRIPTION

Hereinafter, one or more embodiments of the present invention will be described with reference to the drawings. However, the scope of the invention is not limited to the disclosed embodiments.

The active energy ray curable inkjet ink of the present invention is an active energy ray curable inkjet ink containing a pigment, a dispersant, a gelling agent, and an additive. The ink contains, as the dispersant, a compound having a structure derived from a hydroxy fatty acid and a basic functional group, and contains, as the additive, a compound having a pyridine structure.

This feature is a technical feature common to or corresponding to the following embodiments.

In an embodiment of the present invention, from the viewpoint of the storage stability of the ink, the compound having a pyridine structure is preferably an acrylic polymer compound.

From the viewpoint of ejection stability, according to an embodiment of the present invention, it is preferable that the compound having a hydroxy fatty acid-derived structure and a basic functional group has a hydroxystearic acid-derived structure and an amine value is in a range of 10 to 20 mgKOH/g.

In an embodiment of the present invention, from the viewpoints of dispersion stability of the pigment and ejection stability of the ink, the content of the compound having a pyridine structure is preferably in the range of 0.1 to 0.6% by mass relative to the total mass of the active energy ray curable inkjet ink.

In an embodiment of the present invention, from the viewpoints of dispersibility of the pigment and gloss of the image, a mass ratio of the compound having a structure derived from the hydroxy fatty acid and the basic functional group to the compound having the pyridine structure is preferably within a range of 2.73:1 to 16.4:1.

In an embodiment of the present invention, from the viewpoint of image density, the pigment is preferably carbon black or a magenta pigment. The magenta pigment preferably contains any of C. I. Pigment Violet 19, C. I. Pigment Red 122, and C. I. Pigment Red 202.

A method for producing an active energy ray curable inkjet ink according to the present invention is a method for producing the ink described above. The production method preferably includes a step of preparing a pigment dispersion liquid containing the pigment and the dispersant, and a step of preparing the active energy ray curable inkjet ink containing the pigment dispersion liquid, the gelling agent, and the additive.

It is preferred that the inkjet recording method of the present invention uses the ink, an ejection temperature of the ink is in a range of 40 to 120° C., and a temperature of the recording medium is 60° C. or less.

The inkjet recording system of the present invention preferably uses the ink.

The above-described means of the present invention can provide an active energy ray curable inkjet ink that forms the image having improved gloss, a method for producing the same, an inkjet recording method, and an inkjet recording system.

The expression mechanism or action mechanism of the effect of the present invention is not clear, but it is presumed as follows. In the present specification, the “active energy ray curable inkjet ink” is also simply referred to as “ink”.

In the present invention, the term “dispersant” refers to a component contained for the purpose of dispersing the pigment. In the preparation of the ink, first, a pigment dispersion liquid containing a pigment and a dispersant is prepared, which will be described in detail later. Thereafter, the pigment dispersion liquid and other constituent components of the ink are mixed to prepare the ink.

The term “additive” refers to a component contained for the purpose of adjusting the properties of an ink. Although details will be described later, the additives are added when the pigment dispersion liquid and other constituent components of the ink are mixed in the preparation of the ink.

After the ink containing the gelling agent is landed on a recording medium, the viscosity of the ink rapidly increases and the ink is quickly fixed. Therefore, in the ink containing the gelling agent, the pigment tends to aggregate more easily than in the ink containing no gelling agent. As a result, the glossiness of the image formed with an ink containing the gelling agent has no problem in practical use, but there is room for improvement, and further improvement of the glossiness is required.

In the present invention, a compound having the structure derived from the hydroxy fatty acid and the basic functional group is contained as the dispersant. Further, the compound having the pyridine structure is contained as the additive. Note that some of the compounds having the pyridine structure also have the function of dispersing the pigment.

That is, in the preparation of the pigment dispersion liquid, the pigment first acts on the compound having the hydroxy fatty acid-derived structure and the basic functional group as the dispersant. Thereafter, the pigment is considered to act with the compound having the pyridine structure as the additive when mixed with the constituent components of the ink. It is thought that the compound having the structure derived from the hydroxy fatty acid and the basic functional group and the compound having the pyridine structure interact with different sites in the pigment, respectively. It is considered that the pigment interacts with these two kinds of compounds, thereby obtaining high dispersion stability.

As a result of investigation by the present inventors, the effect of the present invention was slight even when these two types of compounds were contained as dispersants. Specifically, even when the pigment dispersion liquid containing the pigment and these two kinds of compounds is prepared, and then the pigment dispersion liquid and other constituent components of the ink are mixed, the effect of the present invention cannot be obtained.

Furthermore, the effect of the present invention was slight even when the compound having the pyridine structure was contained as the dispersant and the compound having the structure derived from the hydroxy fatty acid and the basic functional group was contained as the additive. Specifically, first, the pigment dispersion liquid containing the pigment and the compound having the pyridine structure is prepared. Thereafter, even when the pigment dispersion liquid, the compound having the structure derived from the hydroxy fatty acid and the basic functional group, and other constituent components of the ink were mixed, the effect of the present invention was not obtained.

That is, when these two kinds of compounds are contained in the ink in two stages, these two kinds of compounds effectively act on the pigment. Details are not clear, but it is considered that the two kinds of compounds are probably adhered to the pigment at an optimum ratio. As a result, it is thought that even if the viscosity of the ink rapidly increases on the recording medium, the pigment can be prevented from aggregating excessively.

Hereinafter, the present invention, constituent elements thereof, and forms and aspects for carrying out the present invention will be described in detail. In the present description, when two figures are used to indicate a range of value before and after “to”, these figures are included in the range as a lower limit value and an upper limit value.

### 1. Summary of Active Energy Ray Curable Inkjet Ink

The active energy ray curable inkjet ink according to the present invention is the active energy ray curable ink containing the pigment, the dispersant, the gelling agent, and the additive. The ink contains, as the dispersant, the compound having the structure derived from the hydroxy fatty acid and the basic functional group, and contains, as the additive, the compound having the pyridine structure.

In the present invention, the “active energy ray curable inkjet ink” refers to the inkjet ink that is cured by irradiation with active energy rays. In the present specification, it is also simply referred to as “ink”.

The ink of the present invention can reversibly undergo a sol-gel phase transition depending on temperature by containing the gelling agent. In the present invention, the “sol-gel phase transition” refers to the following series of phenomena. The liquid is in a solution state having fluidity at a high temperature, but is changed to a state in which the entire liquid is gelled and loses fluidity by being cooled to a gelation temperature or less. Conversely, although it is in a state of losing fluidity at low temperature, it returns to a liquid state having fluidity by heating to the solation temperature or higher.

The term “gel” refers to a solidified, semi-solidified, or thickened state in which a substance loses fluidity and aggregates due to interaction between substances, and which is accompanied by a rapid increase in viscosity or elasticity. The interaction occurs in, for example, a lamellar structure formed by a substance, a polymer network formed by a non-covalent bond or a hydrogen bond, a polymer network formed by a physical aggregation state, an aggregation structure of fine particles, or the like. In addition, the interaction also occurs in precipitated microcrystals.

The term “sol” refers to a state in which an interaction generated in a gel state is eliminated and a substance has fluidity and is liquefied.

There are various methods for the phase transition from sol to gel and from gel to sol. The ink of the present invention can undergo a reversible phase transition depending on the temperature. The term “solation temperature” refers to a temperature at which fluidity is exhibited due to solation when an ink in a gelled state is heated. The “gelation temperature” refers to a temperature at which fluidity decreases due to gelation when an ink in a solated state is cooled.

The term “active energy rays” refers to radiation that acts physically and chemically on a polymerization initiator or a polymerizable compound to promote a crosslinking reaction and a polymerization reaction. Specific examples of the active energy rays include visible rays, ultraviolet rays, X-rays, electron beams, α-rays, β-rays, and γ-rays.

### 2. Constituents of Active Energy Ray Curable Inkjet Ink

The ink of the present invention contains the pigment, the dispersant, the gelling agent, and the additive. In addition, the polymerizable compound or the like may be contained as necessary.

Hereinafter, the dispersant, the additive, the pigment, the gelling agent, and other components will be described in this order.

### (1) Dispersant

The ink of the present invention contains, as the dispersant, the compound having the structure derived from the hydroxy fatty acid and the basic functional group. In addition, other dispersants may be contained as necessary to the extent that the effects of the present invention are not impaired.

In the present invention, the “compound having the structure derived from the hydroxy fatty acid and the basic functional group” refers to the compound having the structure derived from the hydroxy fatty acid and having the basic functional group.

Although details will be described later, for example, the compound described below is a reaction product of a polyester or a polyester amide having a structure derived from a hydroxy fatty acid and a polyallylamine. The polyallylamine has an amino group exhibiting basicity. Some of the amino groups of the polyallylamine react with the polyester or polyesteramide having a structure derived from a hydroxy fatty acid to form a salt or an acid amide. Thus, the basic functional group having the function of adsorbing to the pigment can be introduced into the structure derived from the hydroxy fatty acid having the function of solvating. As a result, it functions well as a pigment dispersant.

The dispersant preferably has a function of suppressing aggregation of the pigment by steric hindrance, in addition to the function of adsorbing to the pigment and the function of solvating the pigment. Therefore, the pigment dispersant is preferably a polymer compound.

The content of the dispersant is preferably in a range of 10 to 60% by mass with respect to the total mass of the pigment. When the content of the dispersant is 10% by mass or more, the dispersion stability of the pigment is improved. When the content of the dispersant is 60% by mass or less, the ejection stability of the ink from the inkjet head is improved.

### (1.1) Constituent Components of Polyester Derivative Having Amine Value

Specifically, the dispersant according to the present invention is preferably a compound obtained by modifying a compound having a structure derived from the hydroxy fatty acid with polyallylamine. Further, the compound having the structure derived from the hydroxy fatty acid is preferably a polyester having the structure derived from the hydroxy fatty acid or the co-condensate of the polyester and the polyamide (polyester amide).

Hereinafter, the “compound obtained by modifying the polyester or polyesteramide having the structure derived from the hydroxy fatty acid with the polyallylamine” is also simply referred to as a “polyester derivative having the amine value”.

The term “amine value” refers to the number of mg of potassium hydrate equivalent to the acid required for neutralizing amine components contained in 1 g of the sample. The amine value can be measured in accordance with ASTM D2074. Further, “having the amine value” means that the value of the amine value defined above is more than 0. That is, the “polyester derivative having the amine value” refers to the polyester derivative having the amine component.

The polyester derivative having the amine value has the structure represented by the following general formula (I).

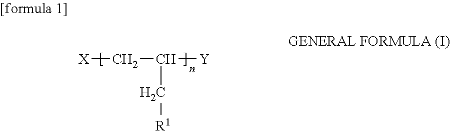

In general formula (I), X and Y each independently represent a hydrogen atom, a polymerization initiator residue, or a chain transfer catalyst residue. R¹ is a group represented by the following general formula (II) or (III). “n” represents an integer within a range of 2 to 1000. However, at least one of n of the R¹ has a group represented by the general formula (III).

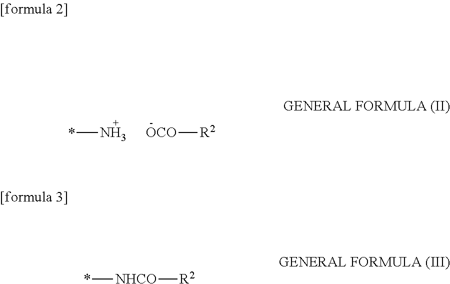

In the general formula (II) and (III), R² represents a residue obtained by removing a carboxyl group from the polyester or polyester amide having the structure derived from the hydroxy fatty acid. * represents the position of the carbon bonded to R¹.

Note that the general formula (II) represents that the carboxy group is modified with the amino group by an ionic bond.

The polyester derivative having the amine value is obtained by reacting the polyester or the polyester amide having the structure derived from the hydroxy fatty acid with the polyallylamine. Hereinafter, each component will be described.

(1.1.1) Compound Having Structure Derived from Hydroxy Fatty Acid

Examples of the compound having the structure derived from the hydroxy fatty acid include the polyester produced from the hydroxy fatty acid as a raw material. In addition, the polyester amide which is the co-condensation product of the polyester and the polyamide is exemplified.

Hereinafter, the polyester and the polyester amide having the structure derived from the hydroxy fatty acid are also simply referred to as “polyester” and “polyester amide”.

The polyester essentially has a structure represented by the following general formula (IV), which is a structure derived from a hydroxy fatty acid. In addition to the structure represented by the following general formula (IV), it may have a structure represented by the following general formula (V). In the polyester, the repeating structures represented by the following general formulas (IV) and (V) may be randomly polymerized.

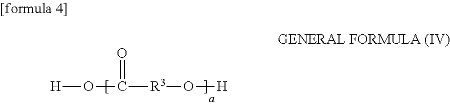

In the general formula (IV), R³ represents a linear or branched alkylene group having 2 to 20 carbon atoms. “a” represents an integer of 2 to 100.

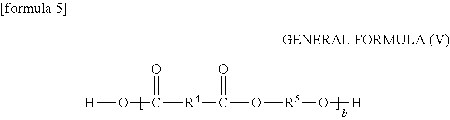

In the general formula (V), R⁴ represents the alkylene group, —C₆H₄—, or —CH═CH—, where the number of carbon atoms is 2 to 20. R⁵ represents the alkylene group having 2 to 20 carbon atoms, or a residue obtained by removing two hydroxy groups from polyalkylene glycol. In R⁴ and R⁵, the alkylene group may be linear or branched. “b” represents an integer of 2 to 100. Further, it may have an ether bond in the chain.

The polyester in the polyesteramide essentially has the structure represented by the general formula (IV), which is the structure derived from the hydroxy fatty acid. In addition to the structure represented by general formula (IV), the structure represented by general formula (V) may be included. In the polyester, the repeating structures represented by the general formulas (IV) and (V) may be randomly polymerized.

The polyamide in the polyester amide has, for example, the structure represented by the following general formula (VI) or (VII). Further, in the polyamide, repeating structures represented by the following general formulas (VI) and (VII) may be randomly polymerized.

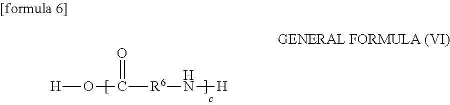

In the general formula (VI), R⁶ represents the linear or branched alkylene group having 2 to 20 carbon atoms. “c” represents an integer of 2 to 100.

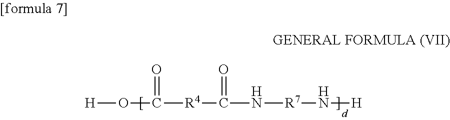

In the general formula (VII), R⁴ represents the alkylene group, —C₆H₄—, or —CH═CH—, where the number of carbon atoms is 2 to 20. R⁷ represents the alkylene group having 2 to 20 carbon atoms. In R⁴ and R⁷ the alkylene group may be linear or branched. “d” represents an integer of 2 to 100.

### (1.1.1.1) Polyester

The synthesis of the polyesters having the structures represented by the above general formulas (IV) and (V) will be described.

### (1.1.1.1.1) Synthesis of Polyester Having Structure Represented by General Formula (IV)

The polyester having the structure represented by the above general formula (IV) can be synthesized using the hydroxy fatty acid having the structure represented by the following general formula (VIII) or the lactone represented by the following general formula (IX) as the raw material. Note that the lactone represented by the following general formula (IX) can be synthesized by dehydration condensation of the hydroxy group and the carboxy group in a molecule of the hydroxy fatty acid.

Specifically, the polyester can be synthesized by adding a polymerization catalyst to each of the hydroxy fatty acid alone, the lactone alone, or a mixture of the hydroxy fatty acid and the lactone, and heating the mixture. The reaction temperature is preferably within a range of 120 to 220° C., more preferably within a range of 160 to 210° C.

Furthermore, the reaction time is preferably within a range of 0.5 to 72 hours. The degree of polymerization can be increased by performing the reaction under a nitrogen airflow. In addition, the use of the polymerization initiator facilitates the control of the reaction. When the lactone is used as the raw material, the amount of the monocarboxylic acid as the polymerization initiator is preferably 0.5 mol or less with respect to 1 mol of the lactone.

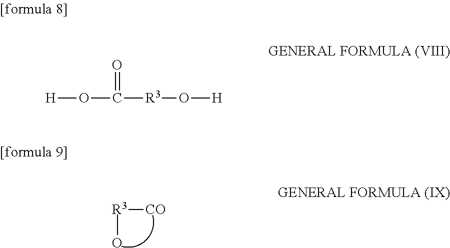

In the general formula (VIII), R³ represents the linear or branched alkylene group having 2 to 20 carbon atoms.

Examples of the hydroxy fatty acids include glycolic acid; 2-hydroxycaproic acid; ricinoleic acid; ricinolenic acid; mixtures of 9 and 10-hydroxystearic acid; 12-hydroxystearic acid; castor oil fatty acid; hydrogenated castor oil fatty acid and lactic acids.

Lactones include, for example, ε-caprolactone, β-propiolactone, γ-butyrolactone, δ-valerolactone, β-methyl δ-valerolactone, 4-methylcaprolactone, 2-methylcaprolactone, etc.

Polymerization catalysts include, for example, quaternary ammonium salts such as tetramethylammonium chloride, tetrabutylammonium chloride, tetramethylammonium bromide, tetrabutylammonium bromide tetramethylammonium iodide, tetrabutylammonium iodide, benzyltrimethylammonium chloride, benzyltrimethylammonium bromide, and benzyltrimethylammonium iodide; quaternary phosphonium salts such as tetramethylphosphonium chloride, tetrabutylphosphonium chloride, tetramethylphosphonium bromide, tetrabutylphosphonium bromide, tetramethylphosphonium iodide, tetrabutylphosphonium iodide, benzyltrimethylphosphonium chloride, benzyltrimethylphosphonium bromide, benzyltrimethylphosphonium iodide, tetraphenylphosphonium chloride, tetraphenylphosphonium bromide, and tetraphenylphosphonium iodide; phosphorus compounds such as triphenylphosphine; organic carboxylates such as potassium acetate, sodium acetate, potassium benzoate, and sodium benzoate; alkali metal alcoholates such as sodium alcoholates, and potassium alcoholates; tertiary amines; organotin compounds; organoaluminum compounds; organotitanate compounds; zinc compounds such as zinc chloride; and the like.

Examples of the polymerization initiator include monocarboxylic acids, for example, aliphatic monocarboxylic acids such as acetic acid, propionic acid, caprylic acid, nonanoic acid, capric acid, octylic acid, lauric acid, myristic acid, palmitic acid, stearic acid, isononanoic acid, and arachic acid; and aromatic monocarboxylic acids such as benzoic acid and p-butylbenzoic acid.

An example of the synthesis of the polyester having the structure represented by the general formula (IV) will be described. The following polyester can be synthesized from ε-caprolactone and 12-hydroxystearic acid.

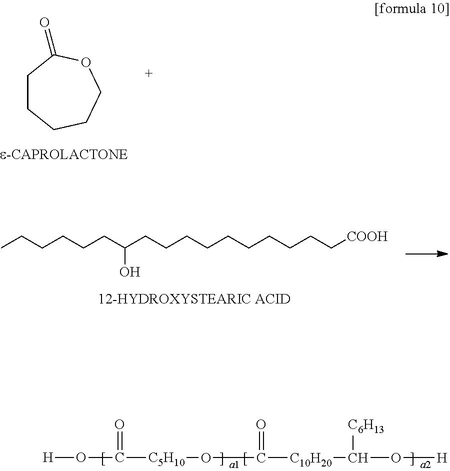

In the polyester to be synthesized, the structure represented by —CO—C₅H₁₀—O— is a repeating structure derived from ε-caprolactone. Furthermore, the structure represented by —CO—C₁₀H₂O—CHC₆H₁₃—O— is a repeating structure derived from 12-hydroxystearic acid. These repeating structures may be randomly polymerized.

In the polyester to be synthesized, a1 and a2 each represent an integer of 1 or more, and the sum of a1 and a2 is an integer of 2 to 100.

### (1.1.1.1.2) Synthesis of Polyester Having Structure Represented by General Formula (V)

The polyester having the structure represented by the general formula (V) can be synthesized by reacting a dibasic acid having a structure represented by the following general formula (X) and a diol having a structure represented by the following general formula (XI).

Specifically, it can be synthesized by adding a polymerization catalyst to a mixture of the above-described dibasic acid and diol, and heating the mixture. Provided that the dibasic acid is preferably added in a slight excess amount. The reaction temperature is preferably within a range of 120 to 220° C., more preferably within a range of 160 to 210° C. Furthermore, the reaction time is preferably within a range of 0.5 to 72 hours. The degree of polymerization can be increased by performing the reaction under a nitrogen airflow. In addition, the use of the polymerization initiator facilitates the control of the reaction.

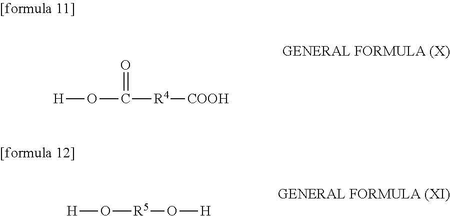

In the general formula (X), R⁴ represents the alkylene group, —C₆H₄—, or —CH═CH—, where the number of carbon atoms is 2 to 20. In the general formula (XI), R⁵ represents the alkylene group having 2 to 20 carbon atoms, or a residue obtained by removing two hydroxy groups from polyalkylene glycol. In R⁴ and R⁵, the alkylene group may be linear or branched.

Examples of the dibasic acid include dibasic acids having an unsaturated bond, such as maleic anhydride and fumaric acid; aromatic dibasic acids, such as phthalic anhydride and terephthalic acid; and saturated dibasic acids, such as adipic acid and sebacic acid.

Examples of the diol include alkylene glycols such as ethylene glycol, propylene glycol, neopentyl glycol, 1,3-butanediol, 1,4-butanediol, 1,6-hexanediol, and ether bond-containing diols such as diethylene glycol; dipropylene glycol and triethylene glycol.

As the polymerization catalyst and the polymerization initiator, those similar to the synthesis of the polyester having the structure represented by the general formula (IV) can be used.

The polyester in which the repeating units represented by the general formulas (IV) and (V) are randomly polymerized can be synthesized by the following method. The polymerization catalyst is added to the mixture of any one of the hydroxy fatty acid alone, the lactone alone, or the mixture of the hydroxy fatty acid and the lactone, and equimolar amounts of the above-described diol and dibasic acid, and the mixture is heated. The reaction conditions are preferably the same as those for the synthesis of the polyester having the structure represented by general formula (IV).

The polyester in which the repeating units represented by the general formulas (IV) and (V) are polymerized in a block form can be synthesized by the following method. The polyester having the structure represented by general formula (IV) and the polyester having the structure represented by general formula (V) are synthesized in advance. Thereafter, these are subjected to dehydration condensation to obtain resin.

The molecular weight of the polyester is preferably within a range of 300 to 20,000. From the viewpoint of the dispersibility of the pigment, the molecular weight is preferably in the range of 1,000 to 10,000. When the molecular weight is within the above range, the side chain of the dispersant can have an appropriate length, and therefore, the dispersibility is excellent. The polyester having a desired molecular weight can be obtained by adjusting the molar ratio among the polymerization initiator, and the hydroxy fatty acid, the lactone, the diol, and the dibasic acid as raw materials. In addition, the polyester having a desired molecular weight can be obtained by observing the acid value of the reaction product and adjusting the reaction time during the synthesis reaction of the polyester.

### (1.1.1.2) Polyesteramide

The polyester amide is a co-condensation product of the above polyester and the following polyamide. The polyamide can be synthesized by subjecting one type or more raw materials for the polyester and one type or more raw materials for the polyamide to a polymerization reaction. In addition, the above-described polyester and the following polyamide can also be synthesized by preliminarily condensing each of the above-described polyester and the following polyamide, and further co-condensing these. The reaction conditions are preferably the same conditions as in the synthesis of the polyamide described below. The molecular weight (degree of polymerization) of the polyester amide can be measured by an acid value.

### (1.1.1.2.1) Synthesis of Polyamide Having Structure Represented by General Formula (VI)

The polyamide having the structure represented by the general formula (VI) can be synthesized using, as raw materials, a lactam having a structure represented by the following general formula (XII) or an aminocarboxylic acid having a structure represented by the following general formula (XIII).

Specifically, it can be synthesized by heating a lactam alone having a structure represented by the following general formula (XII), an aminocarboxylic acid alone having a structure represented by the following general formula (XIII), or a mixture of a lactam and an aminocarboxylic acid. The polycondensation reaction is preferably performed under a nitrogen airflow. The reaction temperature is preferably within a range of 110 to 250° C., more preferably within a range of 150 to 210° C. When the reaction temperature is 250° C. or lower, coloring of the reaction product can be suppressed, and when the reaction temperature is 110° C. or higher, a sufficient reaction rate can be obtained.

The reaction time is preferably within a range of 0.5 to 72 hours. In addition, the use of the polymerization initiator facilitates the control of the reaction. Furthermore, the reaction time can be shortened by adding the polymerization catalyst. The molecular weight of the polyamide can be measured by the acid value. When a lactam is used as the raw material, the amount of the monocarboxylic acid as the polymerization initiator is preferably 0.5 mol or less with respect to 1 mol of the lactam.

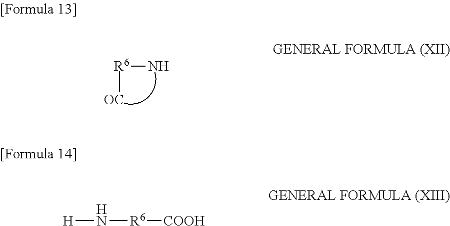

In the general formulas (XII) and (XIII), R⁶ represents the linear or branched alkylene group having 2 to 20 carbon atoms.

Examples of the lactam include e-caprolactam and o-laurolactam. Examples of the aminocarboxylic acid include aminocaproic acid and 11-aminoundecanoic acid. As the polymerization catalyst and the polymerization initiator, those similar to the synthesis of the polyester having the structure represented by the general formula (IV) can be used.

### (1.1.1.2.2) Synthesis of Polyamide Having Structure Represented by General Formula (VII)

The polyamide having the structure represented by the general formula (VII) can be synthesized using, as raw materials, the dibasic acid having the structure represented by the general formula (X) and the diamine represented by the following general formula (XIV).

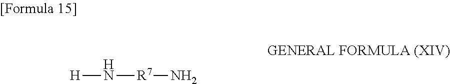

In the general formula (XIV), R⁷ represents a linear or branched alkylene group having 2 to 20 carbon atoms.

Examples of the diamine include ethylene diamine, 1,4-diaminobutane, and hexamethylene diamine.

In the synthesis of the polyamide having the structure represented by the general formula (VII), the reaction conditions and so on can be similar to those in the synthesis of the polyamide having the structure represented by the general formula (VI) described above.

### (1.1.2) Polyallylamine

The polyallylamine is obtained by polymerizing allylamine in the presence of the polymerization initiator, and in some cases, in the presence of a chain transfer catalyst.

The polymerization initiator is not particularly limited, and examples thereof include ketone peroxides such as methylethyl ketone; diacyl peroxides such as benzoyl peroxide; peroxydicarbonates such as diisopropylperoxydicarbonate; peroxyketals such as 1, 1-bis (t-butylperoxy) cyclohexane; hydroperoxides such as t-butyl hydroperoxide; peroxyesters such as t-butyl peroxypivalate; and others such as azobisisoptilinolitrile; hydrogen peroxide; ferrous salts, etc. In addition, polymerization initiators described in Japanese Examined Patent Publication No. H2-14364 may also be used.

The chain transfer catalyst is not particularly limited, and examples thereof include alkyl mercaptans such as lauryl mercaptan; thiocarboxylic acids such as mercaptoacetic acid, 2-mercaptopropionic acid, and 3-mercaptopropionic acid; and thiocarboxylic acid esters such as butyl thioglycolate and 2-ethylhexyl thioglycolate.

The number average molecular weight of the polyallylamine is not particularly limited as long as it is in the range of 150 to 100,000, but is preferably in the range of 600 to 20,000.

When the number average molecular weight is 150 or more, sufficient adsorption to a pigment is obtained. In addition, when the number average molecular weight is 100,000 or less, aggregation of pigments can be suppressed.

As the polyallylamine, a commercially available product may be used. Commercially available products include, for example, those available from Nitto Boseki Co., Ltd., “PAA 1LV”; “PA-1”; “PA-1L”; “PA-1LV”; “PAA-1.4L”; “PAA-10C”; “PAA-15”; “PAA 15B”; “PAA-L”; “PAA-H”; “PAA-1L-15C”.

Furthermore, a polyallylamine having any molecular weight may be synthesized using the method described in Japanese Examined Patent Publication No. H2-14364.

### (1.1.3) Synthesis of Polyester Derivative Having Amine Value

A terminal carboxy group of polyester or polyester amide is modified with polyallylamine to synthesize a polyester derivative having an amine value.

The amount of the polyester or polyesteramide having a free carboxy group is preferably 1 mol or more in total relative to 1 mol of the polyallylamine having n amino groups. Provided that n has the same meaning as n in the aforementioned general formula (I) and is an integer within a range of 2 to 1000. Furthermore, from the viewpoint of pigment-dispersibility, the amount of the polyester or polyesteramide having a free carboxy group is more preferably within a range of 2 to 2n mol.

One type of polyester or polyesteramide may be used alone, or two or more types may be used in combination. Different types of polyesters or polyesteramides may be reacted to polyallylamine at the same time. In the reaction, the polymerization catalyst may be used, and as the polymerization catalyst, the same polymerization catalyst as in the synthesis of the polyester having the structure represented by general formula (IV) can be used. As the reaction solvent, a solvent such as xylene or toluene may also be used.

The reaction between the polyester or polyesteramide and the polyallylamine is a salt formation reaction or an acid amide bond formation reaction via a terminal free carboxy group of the former and a free amino group of the latter. In addition, an ester-amide exchange reaction also occurs at the same time between the ester of the polyester or the polyesteramide and the amino group of the side chain of the polyallylamine, depending on the type of the polyester or the polyesteramide or the reaction conditions. In the reaction of the polyester or the polyester amide with the polyallylamine, whether a salt is formed or an acid amide is formed depends on the reaction conditions.

The salt-forming reaction and the acid amide bond-forming reaction proceed simultaneously. The reaction temperature in the acid amide bond-forming reaction is preferably in a range of 90 to 250° C., more preferably in a range of 90 to 210° C., and still more preferably in a range of 100 to 210° C. When the reaction temperature is 250° C. or lower, coloring of the reaction product can be suppressed, and when the reaction temperature is 90° C. or higher, a sufficient reaction rate can be obtained. In addition, a less colored reaction product is obtained by performing the reaction under a nitrogen airflow.

On the other hand, the reaction temperature in the salt-forming reaction is preferably in the range of 20 to 140° C.

The polyester derivative having an amine value preferably has an acid amide bond. Furthermore, from the viewpoint of pigment dispersibility, it is preferable that the terminal carboxy group of the polyester or the polyester amide reacts at a ratio of 2 mol or more with respect to 1 mol of the polyallylamine having n amino groups. Provided that n has the same meaning as n in the aforementioned general formula (I) and is an integer within a range of 2 to 1000.

In the above general formula (I), the residue in the form of being bonded by an acid amide bond represented by the above general formula (III) is preferably present in the range of 60 to 95%, more preferably in the range of 65 to 90% in the n pieces of R¹.

That is, 60% or more of the amino groups of the polyallylamine are covalently bonded to the polyester or the polyester amide through an amide bond. Thus, aggregation of the pigments can be suppressed, and the pigment can function as the pigment dispersant. In addition, 95% or less of the amino groups of the polyallylamine are covalently bonded to the polyester or the polyester amide through an amide bond. That is, when more than 5% of the amino groups are present as amino groups, the amino groups can be sufficiently adsorbed to the pigment and function as the pigment dispersant.

### (Amine Value)

In the polyester derivative having an amine value, an amino group of the polyallylamine is bonded by a covalent bond within the range described above. For that purpose, the amine value can be calculated by measuring an amine value A immediately after mixing the polyester or polyesteramide having a carboxy group at one end and at least one of the polyallylamines and an amine value B after completion of the reaction, and calculating changes in these values.

$$proportion of covalent bonds of amino groups of polyester derivative having amine value [ \% ] = \{ ( A - B ) / A \} \times 100 \qquad ( formula )$$

The amine value immediately after mixing may be actually measured. Provided that since the reaction does not proceed immediately after the mixing, the amine value of the polyallylamine used as the raw material can also be calculated from the masses of the polyester or polyesteramide added and the polyallylamine used in the reaction. Note that even if a carboxy group of the polyester or the polyester amide and an amino group of the polyallylamine form a salt, there is no effect on the desired amine value.

In the synthesis of the polyester derivative having an amine value, a mass ratio of polyallylamine and polyester or polyesteramide is preferably within a range of 1/5 to 1/30.

The amine value (mgKOH/g) of the polyester derivative having an amine value is preferably in the range of 2.5 to 50, more preferably in the range of 5 to 30, and still more preferably in the range of 10 to 20, from the viewpoint of pigment dispersibility. An amine value of 2.5 or more can enable sufficient adsorption to the pigment, and an amine value of 50 or less can suppress aggregation of the pigments.

The molecular weight of the polyester derivative having an amine value is preferably in the range of 2000 to 100000 from the viewpoint of pigment dispersibility.

In the present invention, the structure derived from a hydroxy fatty acid is not necessarily polyester. The compound having a hydroxy fatty acid-derived structure and a basic functional group according to the present invention may be obtained by modifying a carboxy group of a hydroxy fatty acid with an amine. Furthermore, if necessary, a dibasic acid, a diol, an aminocarboxylic acid, a lactam, or a diamine may be further used.

The polyester derivative having an amine value has a property of well dispersing the pigment in the resin or an organic solvent, and can be used as the pigment dispersant. The pigment dispersion liquid may contain, in addition to the polyester derivative having the amine value, the organic solvent used in the synthesis of the polyester derivative having the amine value. In addition, regarding the polyester derivative having the amine value, after the organic solvent used at the time of synthesis is distilled off, another solvent may be newly added to obtain the pigment dispersion liquid.

In the present invention, since the pigment dispersion liquid is contained in the active energy ray curable inkjet ink, the dispersion medium is preferably a polymerizable compound described below.

### (1.2) Other Dispersants

Examples of the other dispersant which can be used in combination include polymer dispersants other than the above-described dispersants, and surfactants. Among these, the polymer dispersant is preferable.

Examples of the polymer dispersant include (meth) acrylic resin, styrene-(meth) acrylic resin, hydroxy group-containing carboxylic acid ester, salt of long-chain polyaminoamide and high molecular weight acid ester, salts of high molecular weight polycarboxylic acids, salt of long-chain polyaminoamide and polar acid ester, high molecular weight unsaturated acid ester, modified polyurethane, modified polyacrylate, polyether ester type anionic surfactant, naphthalenesulfonic acid formalin condensate salt, aromatic sulfonic acid formalin condensate salt, polyoxyethylene alkyl phosphate ester, polyoxyethylene nonylphenyl ether, stearylamine acetate, and pigment derivatives and the like.

Furthermore, from the viewpoint of improving dispersibility, a dispersion aid may be further contained, if necessary.

### (2) Additive

The ink of the present invention contains a compound having a pyridine structure as an additive. In addition, other additives may be contained as necessary to the extent that the effects of the present invention are not impaired. Other additives will be described later.

### (2.1) Compound Having Pyridine Structure

The compound having the pyridine structure is preferably the polymer compound from the viewpoint of acting on the pigment and contributing to the pigment dispersibility. Specifically, the compound having the pyridine structure is preferably a compound having a structure of a monomer unit represented by the following general formula (1).

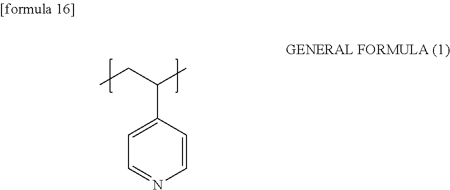

In light of storage stability of the ink, the compound having the pyridine structure is preferably the acrylic polymer compound further having the structure of the monomer unit represented by the following general formula (2) or general formula (3). The acrylic polymer compound is excellent in solvation with the polymerizable compound contained in ink, and therefore good ink storage stability is obtained.

In the present invention, the term “acrylic polymer compound” refers to a polymer obtained by copolymerizing a monomer component containing an acrylic acid ester.

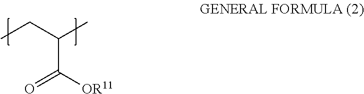

In the general formula (2), R 11 represents the alkyl group in the range of 2 to 15 carbon atoms. The alkyl group for R¹¹ may be linear, branched, or have a ring structure. R¹¹ is preferably the alkyl group having a number of carbon atoms in the range of 2 to 8, more preferably the alkyl group having 4 to 8 carbon atoms, and still more preferably an n-butyl group.

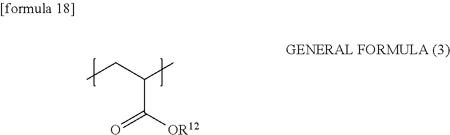

In the general formula (3), R¹² represents a polyalkylene oxide group having a carbon number in the range of 10 to 50 and being terminated by the hydroxy group or the alkoxy group. The polyalkylene oxide group in R² is preferably the polyethylene oxide group or the polypropylene oxide group. R¹² is preferably the polyalkylene oxide group having the carbon number in the range of 10 to 50 and the alkoxy group as a terminal. Among these, the polyalkylene oxide group is more preferably the polyethylene oxide group.

A method for synthesizing the copolymer having the structure of the monomer unit represented by the general formula (1), the monomer unit represented by the general formula (2), and the monomer unit represented by the general formula (3) is not particularly limited. An example of the synthesis method includes living radical polymerization using a nitroxide initiator (NMP initiator).

The content of the monomer unit represented by the general formula (1) is preferably in the range of 5 to 50 mol % and more preferably in the range of 10 to 30 mol % relative to the total number of moles of all the monomers constituting the compound having the pyridine structure. When the content is within the above range, the ink has excellent storage stability.

The molar ratio of the monomer unit represented by the general formula (2) to the monomer represented by the general formula (3) is preferably within a range of 2:1 to 1:2, and more preferably within a range of 1.5:1 to 1:1.5.

The compound having the pyridine structure is preferably a block copolymer. It is more preferable that the block copolymer is composed of a block in which the monomer units represented by the general formula (1) are bonded and a block in which the monomer units represented by the general formula (2) and the monomer units represented by the general formula (3) are randomly bonded. Such a configuration provides excellent storage stability of the ink.

The weight average molecular weight (Mw) of the compound having the pyridine structure is preferably within a range of 10,000 to 70,000. The weight average molecular weight (Mw) is more preferably within a range of 12,000 to 30,000, still more preferably within a range of 13,000 to 25,000, and particularly preferably within a range of 15,000 to 20,000.

The weight average molecular weight can be measured by gel permeation chromatography (GPC). For example, “HLC 8020GPC” (manufactured by Tosoh Corporation) is used as the GPC. As the column, “TSKgel SuperHZM-H, TSKgel SuperHZ4000, TSKgel SuperHZ200” (manufactured by Tosoh Corporation, 4.6 mm ID×15 cm) are used. The measurement is performed by using THF (tetrahydrofuran) as an eluent and setting the set temperature of a column oven to 40° C. For the calculation of the weight average molecular weight, standard polystyrene is used as a reference.

As the compound having a pyridine structure, a commercially available product may be used. Examples of the commercially available product of the compound having the pyridine structure include “DISPERBYK series and BYK series” (manufactured by BYK) and “EFKA series” (manufactured by BASF).

The content of the compound having the pyridine structure is preferably in the range of 0.1 to 0.6% by mass with respect to the total mass of the ink. When the content is 0.1% by mass or more, the storage stability of the ink is improved. When the content is 0.6% by mass or less, an increase in the viscosity of the ink can be suppressed, and the ejection stability is excellent.

The mass ratio of the compound having a structure derived from a hydroxy fatty acid and a basic functional group as the dispersant to the compound having a pyridine structure as the additive is preferably within a range of 2.73:1 to 16.4:1. When the content is within the above range, the effect of the present invention can be remarkably obtained.

### (3) Pigment

The ink of the present invention contains the pigment. The pigment is not particularly limited, and a known pigment can be used.

Examples of the pigments include inorganic pigments such as titanium dioxide, iron oxide, cadmium sulfide, calcium carbonate, barium carbonate, barium sulfate, clay, talc, yellow lead and carbon black. In addition, examples of the pigment include organic pigments such as azo pigments, diazo pigments, condensed azo pigments, thioindigo pigments, indanthrone pigments, quinacridone pigments, anthraquinone pigments, benzimidazolone pigments, perylene pigments, perinone pigments, phthalocyanine pigments, halogenated phthalocyanine pigments, anthrapyridine pigments, and dioxazine pigments.

Among these, the pigment is preferably carbon black or the organic pigment. When the pigment is carbon black or the organic pigment, the storage stability of the ink is improved, and the effects of the present invention can be significantly achieved.

The organic pigment is preferably a magenta pigment. The magenta pigment is preferably C. I. Pigment Violet 19, C. I. Pigment Red 122, or C. I. Pigment Red 202. These may be contained alone or in combination of two or more kinds thereof.

The average particle diameter of the pigment is not particularly limited. However, the average particle diameter is preferably in the range of 0.01 to 0.4 μm, and more preferably in the range of 0.02 to 0.2 μm, from the viewpoint that the finer the particles are, the more excellent the coloring property is. The maximum particle diameter of the pigment is preferably about 3 μm, and more preferably about 1 μm. The particle diameter of the pigment can be adjusted by selection of the type of the pigment, the dispersant, and the dispersion medium, setting of dispersion conditions and filtration conditions, and the like. By controlling the particle size of the pigment, clogging of a head nozzle can be suppressed and the storage stability, transparency, and curing sensitivity of the ink can be maintained.

The particle diameter of the pigment can be measured by a known measurement method. Specifically, it can be measured by a centrifugal sedimentation light transmission method, an X-ray transmission method, a laser diffraction scattering method, or a dynamic light scattering method.

The content of the pigment is preferably in a range of 0.1 to 20% by mass and more preferably in a range of 0.4 to 10% by mass with respect to the total mass of the ink. When the content of the pigment is 0.1% by mass or more, good color developability can be obtained, and when the content is 20% by mass or less, an appropriate viscosity of the ink can be obtained.

### (4) Gelling Agent

In the present invention, the “gelling agent” refers to an organic substance which is solid at normal temperature and becomes liquid when heated. The gelling agent preferably has a melting point in a range of 30 to 150° C. The gelling agent is preferably dissolved in the polymerizable compound described below at a temperature higher than the gelation temperature. The gelling agent is preferably crystallized in the ink at a temperature equal to or lower than the gelation temperature.

The “sol-gel phase transition temperature” refers to a temperature of a change (transition) point at which a change (transition) from a sol state to a gel state occurs. The “sol-gel phase transition temperature” is synonymous with terms referred to as a gel transition temperature, a gel dissolution temperature, a gel softening temperature, a sol-gel transition point, and a gelation point.

When the gelling agent is crystallized in the ink, it is preferable that plate crystals that are crystallized products of the gelling agent form a space that is three dimensionally surrounded. In addition, it is preferable that the plate crystals encapsulate a polymerizable compound in the formed space. Such a structure in which the polymerizable compound is included in the three dimensional space formed by the plate crystal is referred to as a “card house structure”.

By the formation of the card house structure, the liquid polymerizable compound can be held, and the liquid droplets of the ink can be fixed (pinned). Then, the coalescence of the liquid droplets can be suppressed. In order to form the card house structure, it is preferable that the polymerizable compound and the gelling agent dissolved in the ink are compatible with each other. In a case where the polymerizable compound and the gelling agent dissolved in the ink are phase-separated, it is difficult to form the card house structure.

The gelling agent is not particularly limited.

Examples of the gelling agent include ketone waxes such as dilignoceryl ketone, dibehenyl ketone, distearyl ketone, dieicosyl ketone, dipalmityl ketone, dilauryl ketone, dimyristyl ketone, myristyl palmityl ketone, and palmityl stearyl ketone.

Ester waxes such as behenyl behenate, icosyl icosanoate, stearyl stearate, palmityl stearate, cetyl palmitate, myristyl myristate, cetyl myristate, and myricyl cerotate.
petroleum-based waxes such as paraffin wax, microcrystalline wax, and petrolatum;
Vegetable waxes such as candelilla wax, carnauba wax, rice wax, Japan wax, jojoba oil, jojoba solid wax, and jojoba ester;
animal waxes such as beeswax, lanolin, and spermaceti;
mineral-based wax such as montan wax and hydrogenated wax;
hydrogenated castor oil or a hydrogenated castor oil derivative;

Modified waxes such as montan wax derivatives, paraffin wax derivatives, microcrystalline wax derivatives, and polyethylene wax derivatives.
higher alcohols such as stearyl alcohol and behenyl alcohol;
hydroxystearic acid such as 12-hydroxystearic acid and the like;
12-hydroxystearic acid derivatives;
fatty acid amides such as lauric acid amide, stearic acid amide, behenic acid amide, oleic acid amide, erucic acid amide, ricinoleic acid amide, and 12-hydroxystearic acid amide;
N-substituted fatty acid amides such as N-stearyl stearic acid amide and N-oleyl palmitic acid amide;
special fatty acid amides such as N, N′-ethylenebisstearylamide, N, N′-ethylenebis-12-hydroxystearylamide, and N, N′-xylylenebisstearylamide;
higher amines such as dodecylamine, tetradecylamine, octadecylamine and the like;
fatty acid ester compounds such as stearyl stearic acid, oleyl palmitic acid, glycerin fatty acid ester, sorbitan fatty acid ester, propylene glycol fatty acid ester, ethylene glycol fatty acid ester, and polyoxyethylene fatty acid ester;
esters of sucrose fatty acids such as sucrose stearic acid and sucrose palmitic acid;
synthetic waxes such as polyethylene wax and α-olefin-maleic anhydride copolymer wax;
dimer acid;
dimer diol and the like are included.

These may be contained alone or in combination of two or more kinds thereof.

As the gelling agent, a commercially available product may be used.

Examples of commercially available products of ketone wax include “18-Pentatriacontanon” (manufactured by Alfa Aeser), “Hentriacontan-16-on” (manufactured by Alfa Aeser), and “KAO (registered trademark) Wax T1” (manufactured by Kao Corp.).

Examples of the ester wax include “UNISTER (registered trademark) M-2222SL” (manufactured by Nof Corp.), “EXCEPARL (registered trademark) SS” (manufactured by Kao Corp., melting point 60° C.), “EMALEX (registered trademark)CC-18” (manufactured by Nihon Emulsion Co., Ltd), “AMREPS (registered Japanese trademark) PC” (manufactured by Kokyu Alcohol Kogyo Co., Ltd.), “EXCEPARL (registered trademark) MY-M” (manufactured by Kao Corp.), “SPERMACETI” (manufactured by Nof Corp.), “EMALEX (registered trademark) CC-10” (manufactured by Nihon Emulsion Co., Ltd) and the like.

Examples of commercially available products of the fatty acid amide include “Nikkaamide (registered trademark) series” (manufactured by Nippon Kasei Chemical Co., Ltd), “ITOWAX series” (manufactured by Itoh Oil Chemicals Co., Ltd), and “FATTYAMID series” (manufactured by Kao Corp.).

Examples of commercially available products of fatty acid ester compounds include “EMALLEX (registered trademark) series” (manufactured by Nihon Emulsion Co., Ltd), “RIKEMAL (registered trademark) series” (manufactured by Riken Vitamin Co., Ltd), “POEM (registered trademark) series and the like” (manufactured by Riken Vitamin Co., Ltd) and the like.

Examples of commercially available products of sucrose fatty acid esters include “Ryoto Sugar Ester (registered trademark) Series” (manufactured by Mitsubishi Chemical Foods Corporation).

Examples of commercially available products of the synthetic wax include “UNILIN (registered trademark) series” (manufactured by Baker-Petrolite Co., Ltd).

Examples of commercially available products of the dimer diol include “PRIPOR series” (manufactured by CRODA).

Among these, the gelling agent is preferably a ketone wax, an ester wax, a higher fatty acid, a higher alcohol, or a fatty acid amide. In addition, ketone wax or ester wax is more preferable.

Particularly preferable examples of the gelling agent include compounds represented by the following general formula (G1) or (G2).

R²¹—CO—R²² general formula (G1):

R²³—COO—R²⁴ general formula (G2):

In the formula, R²¹ to R²⁴ each independently represents an alkyl chain which has a linear portion having 12 or more carbon atoms and may have a branch.

The general formula (G1) is referred to as ketone wax, and the general formula (G2) is referred to as fatty acid ester. These gelling agents can gelate ink droplets more stably with high reproducibility. Therefore, it is possible to suppress coalescence of ink droplets (dots) landed on the recording medium.

The sol-gel transition temperature of the ink can be arbitrarily set. The sol-gel transition temperature is preferably in a range of 30 to 100° C. from the viewpoint of stable ejection properties of ink droplets, adverse effects associated with high-temperature heating, and the like. The sol-gel transition temperature is preferably a temperature between the temperature of the ink in the inkjet head and the temperature of the recording medium.

The method for measuring the sol-gel transition temperature includes, for example, placing a gel-like test piece on a heat plate. Next, the heat plate is heated, the temperature at which the shape of the test piece collapses is measured, and this temperature can be determined as the sol-gel phase transition temperature. The viscoelasticity can also be measured using a commercially available viscoelasticity measuring apparatus, for example, a viscoelasticity measuring apparatus “MCR300” (manufactured by Physica).

The sol-gel transition temperature can be adjusted by the type, content, and the like of a polymerizable compound described later and the like.

When the temperature of the liquid droplets of the ink ejected from the inkjet head and landed on the recording medium is decreased to a temperature lower than the sol-gel phase transition temperature, the liquid droplets of the ink rapidly become a gel state. Therefore, mixing of dots (ink droplets) and coalescence of dots are suppressed, and a high-quality image can be formed even in high-speed printing. Thereafter, the gelled ink droplets are cured by being irradiated with an active energy ray, and thus are fixed on the recording medium to form a strong image film.

Since the liquid droplets of the ink landed on the recording medium are rapidly gelated, the liquid droplets of the ink are not easily diffused on the recording medium, and it is possible to prevent oxygen from entering the liquid droplets of the ink. Therefore, the curing of the ink is hardly influenced by oxygen inhibition.

The content of the gelling agent is preferably in a range of 1 to 10% by mass and more preferably in a range of 1 to 7% by mass with respect to the total mass of the ink. In a case of containing two or more kinds of gelling agents, it is preferable that the total mass of these is within the above-described range. When the content of the gelling agent is 1% by mass or more, the ink sufficiently undergoes sol-gel phase transition. When the content of the gelling agent is 10% by mass or less, stability of ink ejection from the inkjet head can be obtained.

### (5) Polymerizable Compound

The ink according to the present invention preferably contains a polymerizable compound that is cured by irradiation with active energy rays. An image can be formed even on a recording medium having no ink absorbency by using an ink containing a polymerizable compound.

Examples of the polymerizable compound include a radically polymerizable compound, a cationically polymerizable compound, or a mixture thereof. The compound includes a monomer, a polymer (oligomer or polymer), or a mixture thereof.

The polymerizable compound may be contained alone or in combination of two or more kinds thereof.

The content of the polymerizable compound is preferably in a range of 1 to 97% by mass and more preferably in a range of 30 to 95% by mass with respect to the total mass of the ink.

### (5.1) Radically Polymerizable Compound

The “radically polymerizable compound” refers to a compound having a radically polymerizable ethylenically unsaturated bond. Examples of the radically polymerizable compound include unsaturated carboxylic acid and a salt thereof; an unsaturated carboxylic acid ester compound; an unsaturated carboxylic acid urethane compound; an unsaturated carboxylic acid amide compound and an anhydride thereof; acrylonitrile; styrene; unsaturated polyester; unsaturated polyether; unsaturated polyamide; and unsaturated urethane. Examples of the unsaturated carboxylic acid include; (meth) acrylic acid, itaconic acid, crotonic acid, isocrotonic acid, maleic acid and the like.

Note that in the present specification, (meth) acrylic acid is a generic name for acrylic acid and methacrylic acid, and means one or both of them.

The term “(meth) acrylate” is a generic name for acrylate and methacrylate, and means one or both of them. In addition, the term “acrylate” is a general term for acrylate monomers and acrylate oligomers, and means one or both of these. Similarly, the term “methacrylate” is a general term for a methacrylate monomer and a methacrylate oligomer, and means one or both of them.

Among these, the polymerizable compound is preferably an unsaturated carboxylic acid ester compound; and more preferably a (meth) acrylate compound. The (meth) acrylate compound may be not only a monomer described below but also an oligomer, a mixture of a monomer and an oligomer, a modified product, or the like.

### (5.1.1) (Meth)acrylate Compound

Examples of the (meth) acrylate compound include monofunctional monomers such as isoamyl (meth) acrylate, stearyl (meth) acrylate, lauryl (meth) acrylate, octyl (meth) acrylate, decyl (meth) acrylate, isomyristyl (meth) acrylate, isostearyl (meth) acrylate, 2-ethylhexyl-diglycol (meth) acrylate, 2-hydroxybutyl (meth) acrylate, 2-(meth) acryloyloxyethyl hexahydrophthalic acid, butoxyethyl (meth) acrylate, ethoxydiethylene glycol (meth) acrylate, methoxydiethylene glycol (meth) acrylate, methoxypolyethylene glycol (meth) acrylate, methoxypropylene glycol (meth) acrylate, phenoxyethyl (meth) acrylate, tetrahydrofurfuryl (meth) acrylate, isobornyl (meth) acrylate, 2-hydroxyethyl (meth) acrylate, 2-hydroxypropyl (meth) acrylate, 2-hydroxy-3-phenoxypropyl (meth) acrylate, 2-(meth) acryloyloxyethyl succinate, 2-(meth) acryloyloxyethyl phthalate, 2-(meth) acryloyloxyethyl-2-hydroxyethyl-phthalic acid, t-butylcyclohexyl (meth) acrylate and the like.

Examples of the (meth) acrylate compound include bifunctional monomers such as triethylene glycol di (meth) acrylate, tetraethylene glycol di (meth) acrylate, polyethylene glycol di (meth) acrylate, tripropylene glycol di (meth) acrylate, polypropylene glycol di (meth) acrylate, 1,4-butanediol di (meth) acrylate, 1,6-hexanediol di (meth) acrylate, 1,9-nonanediol di (meth) acrylate, neopentyl glycol di (meth) acrylate, dimethylol-tricyclodecane di (meth) acrylate, bisphenol A-PO adduct di (meth) acrylate, hydroxypivalate neopentyl glycol di (meth) acrylate, and polytetramethylene glycol di (meth) acrylate.

Examples of the (meth) acrylate compound include trifunctional or more polyfunctional monomers such as trimethylolpropane tri (meth) acrylate, pentaerythritol tri (meth) acrylate, pentaerythritol tetra (meth) acrylate, dipentaerythritol hexa (meth) acrylate, ditrimethylolpropane tetra (meth) acrylate, glycerolpropoxy tri (meth) acrylate, and pentaerythritol ethoxy tetra (meth) acrylate.

Among these, from the viewpoint of photosensitivity and the like; the (meth) acrylate compound is preferably stearyl (meth) acrylate, lauryl (meth) acrylate, isostearyl (meth) acrylate, ethoxydiethylene glycol (meth) acrylate, isobornyl (meth) acrylate, tetraethylene glycol di (meth) acrylate, or glycerolpropoxy tri (meth) acrylate.

The (meth) acrylate compound may be a modified product. Examples of the modified product include ethylene oxide-modified (meth) acrylate compounds such as ethylene oxide-modified trimethylolpropane tri (meth) acrylate and ethylene oxide-modified pentaerythritol tetraacrylate; caprolactone-modified (meth) acrylate compounds such as caprolactone-modified trimethylolpropane tri (meth) acrylate; and caprolactam-modified (meth) acrylate compounds such as caprolactam-modified dipentaerythritol hexa (meth) acrylate.

Since the ink of the present invention is of a sol-gel phase transition type, at least a part of the polymerizable compounds is preferably an ethylene oxide-modified (meth) acrylate compound. The ethylene oxide-modified (meth) acrylate compound has high photosensitivity and easily forms a card house structure when the ink gels at a low temperature. In addition, the ethylene oxide-modified (meth) acrylate compound is easily dissolved in other ink components at a high temperature. The ethylene oxide-modified (meth) acrylate compound has small curing shrinkage, and can suppress curling of a printed product.

Examples of ethylene oxide-modified (meth) acrylate compounds include, for example,
4EO modified hexanediol diacrylate “CD561” (molecular weight: 358), 3EO modified trimethylolpropane triacrylate “SR454” (molecular weight: 429), 6EO modified trimethylolpropane triacrylate “SR499” (molecular weight: 560), 4EO modified pentaerythritol tetraacrylate “SR494” (molecular weight: 528) (all manufactured by Sartomer Co., Ltd);
polyethylene glycol diacrylate “NK Ester A-400” (molecular weight: 508), polyethylene glycol diacrylate “NK Ester A-600” (molecular weight: 742), polyethylene glycol dimethacrylate “NK Ester 9G” (molecular weight: 536), and polyethylene glycol dimethacrylate “NK Ester 14G” (molecular weight: 770) (all manufactured by Shin—Nakamura Chemical Co., Ltd).
tetraethylene glycol diacrylate “V #335HP” (manufactured by Osaka Organic Chemical Industry Ltd., molecular weight: 302);
3PO modified trimethylolpropane triacrylate “Photomer (registered trademark) 4072” (manufactured by Cognis, Inc., molecular weight: 471, ClogP:4.90);
1,10-decanediol dimethacrylate “NK ester DOD-N” (molecular weight:310, ClogP:5.75), tricyclodecanedimethanol diacrylate “NK Ester A-DCP” (molecular weight: 304, ClogP:4.69), tricyclodecanedimethanol dimethacrylate “NK Ester DCP” (molecular weight: 332, ClogP:5.12) (all manufactured by Shin—Nakamura Chemical Co., Ltd), and the like.

Here, the “logP value” is a coefficient indicating the affinity of an organic compound for water and 1-octanol. “P” is a 1-octanol/water partition coefficient and is a value of a ratio of equilibrium concentrations of a compound in each solvent in a partition equilibrium state when a very small amount of the compound is dissolved as a solute in a solvent of two liquid phases of 1-octanol and water. The logarithm of the 1-octanol/water partition coefficient with respect to the base 10 is denoted by logP. That is, the “logP value” is a logarithmic value of a 1-octanol/water partition coefficient and is known as an important parameter indicating the hydrophilicity/hydrophobicity of a molecule.

The “ClogP value” is a logP value calculated by calculation. The ClogP value can be calculated by a fragment method, an atomic approach method, or the like. As a specific method for calculating the ClogP value, a fragment method described in a document (C. Hansch and A. Leo, “Substituent Constants for Correlation Analysis in Chemistry and Biology” (John Wiley & Sons, New York; 1969)) is exemplified. In addition, a method using the following commercially available software package 1 or 2 may be mentioned.

Software package 1: MedChem Software (Release 3.54, August 1991, Medicinal Chemistry Project, Pomona College, Claremont, Calif).

Software package 2: Chem Draw Ultra ver. 8.0 (April 2003, Cambridge Soft Corporation, USA).

The numerical value of the ClogP value described in the present specification and the like is the “ClogP value” calculated using the software package 2.

The (meth) acrylate compound may be a polymerizable oligomer. Examples of the polymerizable oligomer include an epoxy (meth) acrylate oligomer, an aliphatic urethane (meth) acrylate oligomer, an aromatic urethane (meth) acrylate oligomer, a polyester (meth) acrylate oligomer, and a linear (meth) acryl oligomer.

### (5.2) Cationically Polymerizable Compound

The term “cationically polymerizable compound” refers to a compound having a cationically polymerizable group in its molecule. Examples of the cationically polymerizable compound include epoxy compounds, vinyl ether compounds, and oxetane compounds. These may be contained alone, or two or more kinds thereof may be contained.

### (5.2.1) Epoxy Compound

Examples of the epoxy compound include aromatic epoxides, alicyclic epoxides, and aliphatic epoxides. Among these, from the viewpoint of enhancing curability, an aromatic epoxide or an alicyclic epoxide is preferable.

Examples of the aromatic epoxide include diglycidyl ether or polyglycidyl ether which is obtained by reacting polyhydric phenol or an alkylene oxide adduct thereof with epichlorohydrin. Examples of the polyhydric phenol or the alkylene oxide adduct thereof to be reacted include bisphenol A or an alkylene oxide adduct thereof. Examples of the alkylene oxide in the alkylene oxide adduct include ethylene oxide, propylene oxide, and the like.

Examples of the alicyclic epoxide include a cycloalkane oxide-containing compound obtained by epoxidizing a cycloalkane-containing compound with an oxidizing agent such as hydrogen peroxide and peracids. Examples of the cycloalkane in the cycloalkane oxide-containing compound include cyclohexene and cyclopentene.

Examples of the aliphatic epoxide include a diglycidyl ether or a polyglycidyl ether obtained by reacting an aliphatic polyhydric alcohol or an alkylene oxide adduct thereof with epichlorohydrin. Examples of the aliphatic polyhydric alcohols include alkylene glycols such as ethylene glycols, propylene glycols, and 1,6-hexanediol. Examples of the alkylene oxide in the alkylene oxide adduct include ethylene oxide, propylene oxide, and the like.

### (5.2.2) Vinyl Ether Compound

Examples of the vinyl ether compound include monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-o-propylene carbonate, dodecyl vinyl ether, diethylene glycol monovinyl ether, octadecyl vinyl ether, and the like.

Examples of the vinyl ether compound include divinyl ether compound, trivinyl ether compound, or the like such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, trimethylolpropane trivinyl ether and the like.

From the viewpoint of curability, adhesion, and the like, a divinyl ether compound or a trivinyl ether compound is preferable.

### (5.2.3) Oxetane Compound

The oxetane compound is a compound having an oxetane ring. Examples of the oxetane compound include oxetane compounds described in Japanese Unexamined Patent Publication No. 2001-220526, Japanese Unexamined Patent Publication No. 2001-310937, Japanese Unexamined Patent Publication No. 2005-255821. Specifically, examples thereof include the compound represented by general formula (1) described in paragraph 0089 of Japanese Unexamined Patent Publication No. 2005-255821, the compound represented by general formula (2) described in paragraph 0092 of the same, the compound represented by general formula (7) in paragraph 0107, the compound represented by general formula (8) in paragraph 0109, and the compound represented by general formula (9) in paragraph 0116.

### (6) Fatty Acid

The ink of the present invention may further contain a fatty acid. When the fatty acid is contained, the storage stability and the ejection stability of the ink are improved. Furthermore, the inclusion of the fatty acid provides good surface slidability of the ink when the ink is ejected onto the recording medium.

The fatty acid is preferably a compound having a carbon number of 12 or more.

Fatty acids include, for example, behenic acid (C₂₂H₄₄O₂), arachidic acid (C₂₀H₄₀O₂), stearic acid (C₁₈H₃₆O₂), palmitic acid (C₆H₃O₂), myristic acid (C₁₄H₂₈O₂), lauric acid (C₁₂H₂₄O₂), oleic acid (C₁₈H₃₄O₂), erucic acid (C₂₂H₄₂O₂) and the like.

As the fatty acid, a commercially available product may be used. Examples of the commercially available product include “Lunac (registered trademark) BA”, “Lunac (registered trade mark) S-90V”, “Lunac (registered trademark) 5-98”, “Lunac (registered trademark) P-70”, “Lunac (registered trademark) P-95”, “Lunac (registered trademark) MY-98”, “Lunac (registered trademark) L-70”, “LUNAC (registered trademark) L-98” (above, Kao Corp.), “NAA (registered trademark)-222S Beads”, “NAA (registered trademark)-222 Powder”, “Bead Stearic Acid Cherry”, “Bead Stearate Camellia”, “Powdered Cherry Stearate”, “Powdered Camellia Stearate”, “NAA (registered trademark)-160”, “NAA (registered trademark)-142”, “NAA (registered trademark)-122”, “NAA (registered trademark)-34”, “NAA (registered trademark)-35”, erucic acid (above, Nof Corp.) and the like.

The content of the fatty acid is preferably in a range of 0.01 to 10 mass ppm, and more preferably in a range of 0.01 to 0.18 mass ppm with respect to the total mass of the ink. When the content is 0.01 mass ppm or more, the storage stability and the ejection stability of the ink are good. Furthermore, when the ink is ejected onto the recording medium, the surface slidability of the ink is good, and so-called sheet jam can be suppressed. When the content is 10 ppm by mass or less, the storage stability of the ink is good.

### (7) Polymerization Initiator

The ink of the present invention may further contain the polymerization initiator. Specifically, the polymerization initiator may not be contained when the active energy rays are electron beams, but the polymerization initiator is preferably contained when the active energy rays are ultraviolet rays.

The polymerization initiator includes an intramolecular bond cleavage type and an intramolecular hydrogen abstraction type.

Examples of the intramolecular bond-cleavage type polymerization initiator include acetophenones such as diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy) phenyl-(2-hydroxy-2-propyl) ketone, 1-hydroxycyclohexyl-phenylketone, 2-methyl-2-morpholino (4-thiomethylphenyl) propan-1-one, 2-benzyl-2-dimethylamino-1-(4-morpholinophenyl)-butanone, etc.; benzoins such as benzoin, benzoin methyl ether, benzoin isopropyl ether, etc.; acylphosphine oxides such as 2,4,6-trimethylbenzoin diphenylphosphine oxide, etc.; benzyl glyoxy ester, methylphenylglyoxy ester and the like.

An example of the intramolecular hydrogen abstraction type polymerization initiator includes benzophenones such as benzophenone, methyl o-benzoylbenzoate-4-phenylbenzophenone, 4,4′-dichlorobenzophenone, hydroxybenzophenone, 4-benzoyl-4′-methyl-diphenyl sulfide, acrylated benzophenone, 3,3′, 4,4′-tetra (t-butylperoxycarbonyl) benzophenone, 3,3′-dimethyl-4-methoxybenzophenone, etc.; thioxanthones such as 2-isopropylthioxanthone, 2,4-dimethylthioxanthone, 2,4-diethylthioxanthone, 2,4-dichlorothioxanthone; aminobenzophenone-based such as Michler's ketone, 4,4′-diethylaminobenzophenone, etc.; 10-butyl-2-chloroacridone, 2-ethylanthraquinone, 9, 10-phenanthrenequinone, camphorquinone and the like.

Although depending on the constituent components of the ink, the content of the polymerization initiator is preferably within a range of 0.01 to 10% by mass relative to the total mass of the ink.

The ink according to the present invention may contain a photoacid generator as the polymerization initiator. Examples of the photoacid generator include compounds used for a chemically amplified photoresist or photocationic polymerization. Details are described in “Organic Materials for Imaging”, edited by the Society for the Study of Organic Electronics Materials, Bunshin Shuppan (1993), pages 187 to 192.

### (8) Polymerization Initiator Aid

The ink of the present invention may further contain a polymerization initiator aid. Examples of the polymerization initiator aid include tertiary amine compounds, and among these, aromatic tertiary amine compounds are preferable.

Examples of the aromatic tertiary amine compound include N,N-dimethylaniline; N,N-diethylaniline; N,N-dimethyl-p-toluidine; n,N-dimethylamino-p-benzoic acid ethyl ester, N,N-dimethylamino-p-benzoic acid isoamylethyl ester, N,N-dihydroxyethylaniline, triethylamine, N,N-dimethylhexylamine, and the like.

Among these, the aromatic tertiary amine compound is preferably N,N-dimethylamino-p-benzoic acid ethyl ester or N,N-dimethylamino-p-benzoic acid isoamylethyl ester. These may be contained alone or in combination of two or more kinds thereof.

### (9) Polymerization Inhibitor

The ink according to the present invention may further contain a polymerization inhibitor. Examples of the polymerization inhibitor include (alkyl) phenol, hydroquinone, catechol, resorcin, p-methoxyphenol, t-butylcatechol, t-butylhydroquinone, pyrogallol, 1,1-picrylhydrazyl, phenothiazine, p-benzoquinone, nitrosobenzene, 2,5-di-t-butyl-p-benzoquinone, dithiobenzoyl disulfide, picric acid, cupferron, aluminum N-nitrosophenylhydroxylamine, tri-p-nitrophenylmethyl, N-(3-oxyanilino-1, 3-dimethylbutylidene) aniline oxide, dibutylcresol, cyclohexanone oxime cresol, guaiacol, o-isopropylphenol, butyraldoxime, methyl ethyl ketoxime, cyclohexanone oxime and the like.

### (10) Others

The ink of the present invention may further contain other components, if necessary. Examples of other components include various additives other than the additives described above, other resins, and the like. Examples of the various additives other than the above-described additives include surfactant, leveling additive, matting agent, ultraviolet absorber, infrared absorbing agent, antimicrobial agent and basic compounds for enhancing the storability of the ink.

Examples of the basic compound include basic alkali metal compounds, basic alkaline earth metal compounds, and basic organic compounds such as amines. Examples of the other resin include a resin for adjusting physical properties of a cured film. Examples of the other resins include, for example, polyester, polyurethane, vinyl resin, acrylic resin, rubber-based resin, and waxes.

### 3. Physical Properties of Active Energy Ray Curable Inkjet Ink

The ink according to the present invention preferably has a viscosity in a range of 3 to 20 mPa·s at 80° C. When the content is within the above range, ejection stability of the ink from an inkjet head can be obtained. In addition, it is preferable that viscosity at 25° C. is 1000 mPa·s or more. When the content is within the above range, the ink can be sufficiently gelled when the temperature of the ink is decreased to room temperature after the ink lands on the recording medium.

The ink preferably has a phase transition temperature of a sol-gel phase transition within a range of 40 to 70° C. When the phase transition temperature of the ink is 40° C. or higher, the ink quickly thickens after landing on the recording medium, making it easier to be fixed. In addition, when the phase transition temperature of the ink is 70° C. or lower, ejection stability of the ink is obtained in a case where the temperature at the time of ejection of the ink is set to about 80° C. which is the temperature that the ink is usually used.

The viscosity at 25° C., the viscosity at 80° C., and the phase transition temperature of the ink can be determined by measuring a temperature change in the dynamic viscoelasticity of the ink using a rheometer. For example, the ink is heated to 100° C. and is cooled to 20° C. under conditions of a shear rate of 11.7 (1/s) and a temperature lowering rate of 0.1° C./s while the viscosity is measured by a stress control-type rheometer, to obtain a temperature change curve of the viscosity. As the stress control-type rheometer, for example, “Physica MCR301” (cone plate diameter: 75 mm, cone angle: 1.0°, manufactured by AntonPaar) can be used.

The viscosity at 25° C. and the viscosity at 80° C. are obtained by reading the viscosities at 25° C. and 80° C., respectively, in a viscosity-temperature change curve. The phase transition temperature is determined as a temperature at which the viscosity becomes 200 mPa·s in a temperature change curve of the viscosity.

### 4. Method for Producing Active Energy Ray Curable Inkjet Ink

A method for producing the active energy ray curable inkjet ink according to the present invention is characterized by comprising the steps of: preparing the pigment dispersion liquid containing the pigment and the dispersant; and preparing the active energy ray curable inkjet ink containing the pigment dispersion liquid, the gelling agent, and the additive. That is, first, the pigment dispersion liquid is prepared, and then mixed with other components to prepare the ink.

### (1) Preparing Pigment Dispersion Liquid Containing Pigment and Dispersant

In the above step, the pigment dispersion liquid containing the pigment and the dispersant is prepared. Note that the compound having the pyridine structure also has a function of dispersing the pigment, but in the present invention, the compound having the pyridine structure is added as the additive in the next step.

The method for preparing the pigment dispersion liquid is not particularly limited, and the pigment dispersion can be prepared by a known method. The dispersion medium of the pigment dispersion liquid is preferably a low-molecular-weight polymerizable compound having a relatively low viscosity from the viewpoints of dispersibility and handling properties with the polymerizable compound.

The pigment dispersion liquid can be prepared by dispersing the pigment in the polymerizable compound using the above-described dispersant. The pigment can be dispersed using, for example, a ball mill, a sand mill, an attritor, a roll mill, an agitator, a Henschel mixer, a colloid mill, an ultrasonic homogenizer, a pearl mill, a wet jet mill, or a paint shaker.

### (2) Preparing Active Energy Ray Curable Inkjet Ink Containing Pigment Dispersion Liquid, Gelling Agent, and Additive

Through the above process, the ink containing the pigment dispersion liquid, the gelling agent, and the additives is prepared.

The method for mixing the constituent components of the ink is not particularly limited, and the constituent components can be mixed by a known method. For example, other constituent components of the ink may be added to the prepared pigment dispersion liquid, and mixed with heating. The obtained mixed solution is preferably filtered through a predetermined filter.

### 5. Inkjet Recording Method

The inkjet recording method of the present invention is an inkjet recording method in which the ejected ink described above is landed on the recording medium to perform recording. An ejection temperature of the ink is in a range of 40 to 120° C., and a temperature of the recording medium is 60° C. or lower.

In the inkjet recording method of the present invention, the above ink is used. Specifically, when a multicolor image is formed using a plurality of types of inks having different compositions, at least one type of the plurality of types of inks is to be the ink according to the present invention.

An inkjet printer is used in the inkjet recording method of the present invention. Generally, inkjet printers are classified into an on-demand system and a continuous system according to an ink ejection method. The inkjet printer used in the present invention may be of either type. Examples of the on-demand type inkjet printer include electro-mechanical conversion types including a single cavity type, a double cavity type, a bender type, a piston type, a share mode type, and a shared wall type; and electro-thermal conversion types including a thermal inkjet type and a bubble jet (Bubble Jet is a trademark of CANON INC) type.

Furthermore, inkjet printers are divided into a scanning method and a line method according to the scanning method of the head. The inkjet printer used in the present invention may be of either type. Either method may be selected according to the resolution of the recorded matter (image) and the recording speed. Since the ink of the present invention can be quickly fixed, recorded matter having high image quality can be obtained even in high-speed recording by a line system.

The recording medium may be any recording medium on which an image can be formed using the ink of the present invention. Examples of the recording media include non-absorbent recording media composed of plastics including polyester, polyvinyl chloride, polyethylene, polyurethane, polypropylene, acrylic resin, polycarbonate, polystyrene, acrylonitrile-butadiene-styrene copolymer, polyethylene terephthalate and polybutadiene terephthalate; non-absorptive inorganic recording medium such as metals, glass, etc.; sheet such as coated sheet for printing, coated sheet B for printing, etc.

Examples of the plastic film include a PP film; PET film; OPS film; OPP film; ONy film; PVC film; PE film and TAC film.

(1) Ejecting Ink from Head

In a process of ejecting ink from the head, droplets of ink are ejected from the nozzle of the head. The ejection method is not particularly limited.

The temperature of the ink in the head is preferably in a range of 40 to 120° C., and more preferably in a range of 50 to 85° C. When the temperature of the ink in the head is 40° C. or more, ejection stability of the ink from the head is obtained. In addition, when the temperature is 120° C. or lower, volatilization of the components of the ink can be suppressed, and a thermal load on the head can be reduced.

When the temperature of the ink is within a range of 40 to 120° C., the viscosity of the ink is preferably within a range of 3 to 20 mPa·s.

Furthermore, it is preferable that the temperature of the ink in the head is made higher than the gelation temperature of the ink by 10 to 40° C. When the temperature of the ink in the head is set to be equal to or higher than the gelation temperature+10° C., the ink can be satisfactorily ejected without being gelled in the head or on a nozzle surface. In addition, setting the temperature of ink in the head to the gelation temperature+40° C. or less can reduce the thermal load on the head. In particular, in the head using a piezoelectric element, performance deterioration due to the thermal load is likely to occur, and thus the temperature of the ink in the head is preferably set to be in the above-described range.

The method of heating the ink is not particularly limited. For example, the ink can be heated by heating at least one of an ink supply system, a pipe with a filter, a piezoelectric head, and the like with a panel heater, a ribbon heater, heat-retaining water, or the like. Examples of the ink supply system include an ink tank constituting a head carriage, a supply pipe, and a front chamber ink tank immediately before the head.

From the viewpoint of recording speed and image quality, the droplet amount of the ink at the time of ejection is preferably within a range of 2 to 20 pL.

### (2) Landing Ink on Recording Medium

In the step of directly landing ink on the recording medium, the ink ejected in the preceding step is landed on the recording medium.

In light of fixing of the ink, the temperature of the recording medium is preferably lower than the temperature at the time of ejection of the ink and 60° C. or less.

When the temperature of the recording medium is 60° C. or less, the landed ink is rapidly thickened and thus can be fixed.

(3) Irradiating Ink with Active Energy Rays to Cure Ink

In the process of curing the ink by irradiating the ink with active energy rays, the surface of the recording medium on which the ink has landed is irradiated with active energy rays.

As described above, examples of the active energy rays include visible rays, ultraviolet rays, X-rays, electron beams, α-rays, β-rays, and γ-rays. Among these, irradiation with ultraviolet rays is preferable from the viewpoint of ease of handling and less influence on a human body. In addition, it is preferable to irradiate an electron beam from the viewpoint of easily curing the ink.

The light source of the ultraviolet rays is preferably a light emitting diode (LED). By using the LED, it is possible to prevent ink from being melted by radiation heat of the light source and curing failure of the ink from occurring. Examples of the LED light source include a water-cooled LED having a wave length of 395 nm, and examples thereof include those manufactured by Phoseon Technology, Heraeus, Kyocera, HOYA, and Integration Technology.

The amount of energy of the active energy rays to be applied is preferably within a range of 200 to 1000 mJ/cm². When the amount of energy is 200 mJ/cm² or more, the polymerizable compound can be sufficiently polymerized and crosslinked. When the energy amount is 1000 mJ/cm² or less, a decrease in the viscosity of the ink due to heat of active energy rays can be suppressed, and a decrease in the pinning property can be suppressed. From the above-described viewpoint, the energy amount of the active energy rays to be applied is more preferably in a range of 300 to 800 mJ/cm² and even more preferably in a range of 350 to 500 mJ/cm².

### (4) Drying Ink

In the step of drying the ink, after the ink is irradiated with active energy rays, drying is performed as necessary. The drying method may be air drying or drying by heat application, but drying by heat application is preferable.

### 6. Inkjet Recording System

The inkjet recording system of the present invention is an inkjet recording system that performs recording by causing the ejected ink to land on the recording medium. That is, the present invention is characterized by using the above-described ink.

The image forming apparatus for forming an image using the ink of the present invention will be described. Note that an apparatus for forming the image by a single-pass method is described below, but the ink of the present invention is also used for an apparatus for forming the image by a scanning method.

FIGURE is a schematic diagram illustrating an exemplary configuration of an image forming apparatus 100 used in the present invention. As illustrated in FIGURE, the image forming apparatus 100 includes an inkjet head 110, a conveyance path 120, an active energy ray irradiation section 130, and a temperature controller 140. In FIGURE, an arrow A indicates a conveyance direction of a recording medium 150. The inkjet head 110 and the active energy ray irradiation section 130 are arranged in this order in contact with the conveyance path 120 from the upstream side to the downstream side in the conveyance direction of the recording medium. Note that the image forming apparatus 100 may have an oxygen concentration adjustment section (not illustrated) for adjusting the oxygen concentration when the ink is irradiated with active energy rays.

As illustrated in FIGURE, the image forming apparatus 100 includes an ink channel 170 and an ink tank 180 that stores ink to be supplied through the ink channel 170. The ink channel 170 is connected to a head carriage 160 that houses the inkjet head 110 for ink.

The head carriage 160 houses each of the inkjet heads 110. The head carriage 160 includes inkjet heads for respective colors of yellow (Y), magenta (M), cyan (C), and black (K). The head carriage 160 is fixedly disposed so as to cover, for example, the entire width of the recording medium 150.

The ink tank 180 stores ink of each color. The inkjet head 110 is supplied with ink from the ink tank 180. Note that the ink of the present invention may be used for all of the yellow (Y), magenta (M), cyan (C), and black (K) inks, or the ink of the present invention may be used for only some of the inks. In particular, the ink of the present invention is preferably used as a magenta ink or a black ink.

The inkjet head 110 ejects ink supplied from the ink tank 180 to the head carriage 160 via the ink channel 170. At this time, the ink is preferably heated via the ink tank 180, the ink channel 170, the head carriage 160, the inkjet head 110, and the like. As described above, the temperature of the ejected ink is preferably within a range of 40 to 120° C., and more preferably within a range of 50 to 85° C.

The active energy ray irradiation section 130 covers the entire width of the recording medium 150, and is disposed on the downstream side of the head carriage 160 in the conveyance direction A of the recording medium 150. The active energy ray irradiation section 130 emits active energy rays to the ink droplets ejected from the inkjet heads 110 and landed on the recording medium 150 to cure the ink droplets.

The temperature controller 140 is disposed on the lower surface of the recording medium 150. The temperature controller 140 adjusts the temperature of the surface of the recording medium 150 to be lower than the temperature at the time of ejecting the ink and to be 60° C. or lower. Examples of the temperature controller 140 include various heaters. Thus, the ink of the present invention is quickly fixed after landing on the recording medium 150. Therefore, the ink of the present invention has high pinning properties and can suppress the bleeding of the polymerizable compound from the formed dot.

In addition, an oxygen concentration adjustment section (not shown) adjusts the oxygen concentration of an atmosphere which takes in the surface of the ink landed on the recording medium 150 when the active energy ray is irradiated.

### EXAMPLES

Hereinafter, the present invention will be specifically described with reference to Examples, but the present invention is not limited thereto. In the examples, “part(s)” or “%” means “part(s) by mass” or “% by mass” unless otherwise specified.

In the following examples, operations were performed at room temperature (25° C.) unless otherwise specified.

### 1. Synthesis of Various Compounds

### (1) Synthesis of Dispersant

Compounds 1 to 4 were synthesized as compounds having a structure derived from a hydroxy fatty acid and a basic functional group. In addition, a compound 5 was synthesized as a comparative compound. The compound 5 did not correspond to a compound having a hydroxy fatty acid-derived structure and a basic functional group.

### (1.1) Synthesis of Compound 1

The following components were placed in a reaction flask equipped with a thermometer, a stirrer, a nitrogen gas inlet, and a reflux tube and heated at 170° C. under a nitrogen gas stream. Note that the heating was performed until the residual amount of ε-caprolactone became 1% or less. The reaction time was about 4 hours. Then, the temperature of the reaction product was cooled to room temperature to obtain polyester 1.

Glycolic acid (manufactured by Junsei Chemical Co., Ltd) 10.00 parts by mass

ε-caprolactone (manufactured by Junsei Chemical Co., Ltd): 1306.00 parts by mass

Tetrabutyl titanate (manufactured by Junsei Chemical Co., Ltd) 0.07 parts by mass

The polyester 1 had a number-average molecular weight of 8570 and an acid number of 6.3 mgKOH/g.

The following components were prepared in the reaction flask used to obtain the polyester 1.

Toluene 115.50 parts by mass

10% aqueous polyallylamine (“PAA 1 LV” manufactured by Nitto Boseki Co., Ltd., number-average molecular weight: about 3000) 70.00 parts by mass

While this mixture was stirred at 120° C., water was distilled off using a separator, and toluene was returned to the reaction solution. After confirming that 50% by mass of water was distilled off, the following components heated to 120° C. were added while toluene was returned to the reaction solution, and the mixture was reacted at 120° C. for 5 hours. Thus, the compound 1 was obtained.

Polyester 1 70.00 parts by mass

The compound 1 had a solids content of 40.2%, an amine value of 5.0 mgKOH/g, and an acid value of 4.9 mgKOH/g.

### (1.2) Synthesis of Compound 2

The following components were placed in a reaction flask equipped with a thermometer, a stirrer, a nitrogen gas inlet, and a reflux tube and heated at 170° C. under a nitrogen gas stream. Note that the heating was performed until the residual amount of ε-caprolactone became 1% or less. The reaction time was about 3.5 hours. Then, the temperature of the reaction product was cooled to room temperature to obtain polyester 2.

2-hydroxycaproic acid (manufactured by Junsei Chemical Co., Ltd): 10.00 parts by mass ε-caprolactone (manufactured by Junsei Chemical Co., Ltd): 506.00 parts by mass Tetrabutyl titanate (manufactured by Junsei Chemical Co., Ltd) 0.03 parts by mass

The polyester 2 had a number-average molecular weight of 5630 and an acid number of 9.6 mgKOH/g.

The following components were prepared in the reaction flask used to obtain the polyester 2.

Toluene 194.25 parts by mass

10% aqueous polyallylamine (“PAA 1 LV” manufactured by Nitto Boseki Co., Ltd., number-average molecular weight: about 3000) 70.00 parts by mass

While this mixture was stirred at 120° C., water was distilled off using a separator, and toluene was returned to the reaction solution. After confirming that 50% by mass of water was distilled off, the following components heated to 120° C. were added while toluene was returned to the reaction solution, and the mixture was reacted at 120° C. for 5 hours. Thus, the compound 2 was obtained.

Polyester 2 122.50 parts by mass

The compound 2 had a solids content of 40.2%, an amine value of 5.0 mgKOH/g, and an acid value of 8.2 mgKOH/g.

### (1.3) Synthesis of Compound 3

The following components were placed in a reaction flask equipped with a thermometer, a stirrer, a nitrogen gas inlet, and a reflux tube and heated under a nitrogen gas stream. The temperature was raised to 160° C. over 4 hours, and the mixture was heated at 160° C. for 2 hours, and then heated until the residual amount of ε-caprolactone became 1% or less. The reaction time was about 3.5 hours. Then, the temperature of the reaction product was cooled to room temperature to obtain polyester 3.

12-hydroxystearic acid (manufactured by Junsei Chemical Co., Ltd) 10.00 parts by mass

ε-caprolactone (manufactured by Junsei Chemical Co., Ltd): 60.00 parts by mass

Tetrabutyl titanate (manufactured by Junsei Chemical Co., Ltd) 0.01 parts by mass

The polyester 3 had a number-average molecular weight of 2050 and an acid number of 26.3 mgKOH/g.

The following components were prepared in the reaction flask used to obtain the polyester 3.

Toluene 194.30 parts by mass

10% aqueous polyallylamine (“PAA 1 LV” manufactured by Nitto Boseki Co., Ltd., number-average molecular weight: about 3000) 70.00 parts by mass

While this mixture was stirred at 120° C., water was distilled off using a separator, and toluene was returned to the reaction solution. After confirming that 50% by mass of water was distilled off, the following components heated to 120° C. were added while toluene was returned to the reaction solution, and the mixture was reacted at 120° C. for 5 hours. Thus, the compound 3 was obtained.

Polyester 3 122.50 parts by mass

The compound 3 had a solids content of 40.2%, an amine value of 10.0 mgKOH/g, and an acid value of 23.2 mgKOH/g.

### (1.4) Synthesis of Compound 4

The following components were placed in a reaction flask equipped with a thermometer, a stirrer, a nitrogen gas inlet, and a reflux tube and heated under a nitrogen gas stream. The temperature was raised to 160° C. over 4 hours, and the mixture was heated at 160° C. for 2 hours, and then heated until the residual amount of ε-caprolactone became 1% or less. The reaction time was about 3.5 hours. Then, the temperature of the reaction product was cooled to room temperature to obtain polyester 4.

12-hydroxystearic acid (manufactured by Junsei Chemical Co., Ltd) 10.00 parts by mass

ε-caprolactone (manufactured by Junsei Chemical Co., Ltd): 80.00 parts by mass

Tetrabutyl titanate (manufactured by Junsei Chemical Co., Ltd) 0.01 parts by mass

The polyester 4 had a number-average molecular weight of 2920 and an acid number of 18.5 mgKOH/g.

The following components were prepared in the reaction flask used to obtain the polyester 4.

Toluene 194.30 parts by mass

10% aqueous polyallylamine (“PAA 1 LV” manufactured by Nitto Boseki Co., Ltd., number-average molecular weight: about 3000) 70.00 parts by mass

While this mixture was stirred at 120° C., water was distilled off using a separator, and toluene was returned to the reaction solution. After confirming that 50% by mass of water was distilled off, the following components heated to 120° C. were added while toluene was returned to the reaction solution, and the mixture was reacted at 120° C. for 5 hours. Thus, the compound 4 was obtained.

Polyester 4 122.50 parts by mass

The compound 4 had a solids content of 40.2%, an amine value of 20.0 mgKOH/g, and an acid value of 15.0 mgKOH/g.

### (1.5) Synthesis of Compound 5

The following components were charged into a reaction flask equipped with a thermometer, a stirrer, a nitrogen introduction port, a reflux tube, and a dropping funnel, and the temperature was raised to 85° C.

Xylene 348.0 parts by mass

Next, a mixed liquid of the following components was continuously added dropwise into the reaction flask over 2 hours, and then polymerized at 85° C. for 1 hour.

Methyl methacrylate 190.0 parts by mass

Butyl methacrylate 158.0 parts by mass

2-Ethylhexyl methacrylate 75.0 parts by mass

Styrene 60.0 parts by mass

Acrylic acid 7.0 parts by mass

2-hydroxyethyl methacrylate 110.0 parts by mass

Azobisisobutyronitrile 11.0 parts by mass

Dimethylacetamide 30.0 parts by mass

Thereafter, a solution in which the following components were mixed and dissolved was added into the reaction flask, a polymerization reaction was further performed at 85° C. for 5 hours, and the reaction was completed. Thus, an acrylic resin 1 was obtained.

Azobisisobutyronitrile 1.0 parts by mass

Dimethylacetamide 10.0 parts by mass

Separately, the following components were charged into a reactor flask equipped with a thermometer, a stirrer, a nitrogen gas inlet, and a reflux tube.

Toluene 194.30 parts by mass

Polyallylamine 10% aqueous solution (“PA-1” manufactured by Nitto Boseki Co., Ltd., number average molecular weight: about 3000) 70.00 parts by mass

While this mixture was stirred at 120° C., water was distilled off using a separator, and toluene was returned to the reaction solution. After confirming that 50% by mass of the water had been distilled off, the above-described acrylic resin 1 whose temperature had been raised to 120° C. was added while returning toluene to the reaction solution, and a reaction was performed at 120° C. for 5 hours. Thus, the compound 5 was obtained.

Acrylic resin 1 122.50 parts by mass

Compounds 1 to 4 having a structure derived from a hydroxy fatty acid and a basic functional group as dispersants and compound 5 as a comparison were synthesized as described above. The combinations of the modifying resin and the polyallylamine component in compounds 1 to 5 are as in the following Table I. Note that polyester was used as the modifying resin for compounds 1 to 4. For the compound 5, an acrylic resin was used as a modifying resin in place of polyester.

In addition, the amine values of compounds 1 to 5 are listed in Table I.

TABLE I

| | POLYESTER | | | | | |
|---|---|---|---|---|---|---|
| COMPOUND | | | HYDROXY FATTY | OTHER | | AMINE VALUE |
| No. | No. | LACTONE | ACID | RESINS | POLYALLYLAMINE | [mgKOH/g] |
| COMPOUND | 1 | ε -CAPROLACTONE | GLYCOLIC ACID | — | PAA-1LV | 5 |
| 1 | | | | | | |
| COMPOUND | 2 | ε -CAPROLACTONE | 2-HYDROXYCAPROIC | — | PAA-1LV | 5 |
| 2 | | | ACID | | | |
| COMPOUND | 3 | ε -CAPROLACTONE | 12-HYDROXYSTEARIC | — | PAA-1LV | 10 |
| 3 | | | ACID | | | |
| COMPOUND | 4 | ε -CAPROLACTONE | 12-HYDROXYSTEARIC | — | PAA-1LV | 20 |
| 4 | | | ACID | | | |
| COMPOUND | — | | | ACRYLIC | PA-1 | — |
| 5 | | | | RESIN | | |

### (2) Synthesis of Additives

Compounds 7 and 8 were synthesized as compounds having a pyridine structure.

As the compound 6, poly (4-vinylpyridine) was used.

As compound 9, “Efka (registered trademark) PX4701” (acryl block copolymer, manufactured by BASF) was used.

As the compound 10, “TEGO (registered trademark) Dispers 655” (phosphate ester of a specially modified polyether polymer, manufactured by Evonik Industries AG) was used. Note that compound 10 was a comparative compound and did not correspond to a compound having a pyridine structure.

Furthermore, among the compounds 6 to 9, the compounds 7 to 9 were acrylic polymers.

### (2.1) Synthesis of Compound 7

### (1st Step: Synthesis of Polyacrylate)

In a reaction flask, the following components were uniformly mixed under a nitrogen atmosphere within a range of 15 to 30° C. During mixing, degassing and N2 substitution treatment were performed within a range of 2 to 4 times. Thereafter, the mixture was heated in an oil bath heated within a range of 100 to 130° C., and a polymerization reaction was performed within a range of 5 to 15 hours. When the solid content reached 50 vol %, the reaction product was cooled with liquid nitrogen to stop the reaction. Thereafter, the unreacted monomers were removed by vacuum distillation to obtain a polyacrylate.

NMP initiator 1 12.00 parts by mass

NMP initiator 2 4.00 parts by mass

n-Butyl acrylate (manufactured by Mitsubishi Chemical Corporation) 84.00 parts by mass

Details of the NMP initiator are shown below.

NMP initiator 1:

N-tert-Butyl-N-(2-Methyl-1-phenylpropyl)-O-(1-phenylethyl) hydroxylamine (manufactured by Aldrich, product number 700703).

NMP initiator 2:2,2,5-Trimethyl-4-phenyl-3-azahexane-3-nitroxide (manufactured by Aldrich, product number 710733).

### (2nd Step: Synthesis of Polyacrylate-Poly (Vinylpyridine))

In a reaction flask, the following components were uniformly mixed under a nitrogen atmosphere within a range of 15 to 30° C. During mixing, degassing and N2 substitution treatment were performed within a range of 2 to 4 times. Thereafter, the mixture was heated in an oil bath heated within a range of 100 to 140° C., and a polymerization reaction was performed within a range of 2 to 5 hours. When the solid content reached 90 vol %, the reaction product was cooled with liquid nitrogen to stop the reaction. Thereafter, the unreacted monomers were removed by vacuum distillation to obtain polyacrylate-poly (vinylpyridine).

NMP initiator 2 2.00 parts by mass

Polyacrylate obtained in first step 66.00 parts by mass

4-vinylpyridine “V0025” (manufactured by Tokyo Chemical Industry Co., Ltd) 32.00 parts by mass

### (3rd Step: Synthesis of Polymer Having Pyridine Skeleton)

In a reaction flask, the following components were uniformly mixed under a nitrogen atmosphere within a range of 15 to 30° C. During mixing, degassing and N2 substitution treatment were performed within a range of 2 to 4 times. Thereafter, the mixture was heated in an oil bath heated within a range of 100 to 140° C. Thereafter, 0.2 parts by mass of a 10% methanol solution of lithium methanolate (manufactured by Aldrich, product code 62562) as a catalyst solution was added, and the mixture was distilled under reduced pressure. This was repeated five times at one hour intervals. Then, the reaction product was cooled with liquid nitrogen to stop the reaction, thereby obtaining compound 7.

polyacrylate-poly (vinylpyridine) obtained in the second step 33.00 parts by mass

poly (ethylene glycol) methyl ether (Mw=550 g/mol, manufactured by Wako Pure Chemical Industries, Ltd., product code 041561) 66.00 parts by mass

### (2.2) Synthesis of Compound 8

### (a: Synthesis of Macromonomer)

The following components were added to a reaction vessel.

One terminal-aminated polypropylene glycol-polyethylene glycol monomethyl ether copolymers “Genamin M41/2000” (manufactured by Clariant). 100.00 parts by mass

Then, the following components were added dropwise to the reaction vessel over 30 minute while cooling with water.

2-isocyanatoethyl methacrylate 7.82 parts by mass

After the dropwise addition, a part of the reaction liquid was sampled, and it was confirmed by infrared spectroscopy (IR) that the isocyanate group derived from MOI almost completely disappeared and a urea bond was formed. Thus, it was confirmed that a macromonomer was produced.

The number average molecular weight of the obtained macromonomer was measured by gel permeation chromatography (GPC) using tetrahydrofuran (THF) as a developing solvent. The number average molecular weight (Mn) of the macromonomer in terms of polystyrene was 3, 300, and the dispersity (PDI=Mw (weight average molecular weight)/Mn (number average molecular weight)) was 1.16.

### (b: Synthesis of Polymer)

The following components were added to the reaction vessel.

polypropylene glycol “UNIOL D-1200” (manufactured by NOF CORPORATION) 137.60 parts by mass

2-ethylhexyl methacrylate 16.00 parts by mass

α-methylstyrene 1.50 parts by mass

4-vinylpyridine 12.00 parts by mass

The mixture was heated to 70° C. while bubbling with nitrogen, and then the following components were added and polymerized for 4 hours.

2, 2′-azobis (dimethyl isobutyrate) “V-601” (manufactured by FUJIFILM Wako Pure Chemical Industries, Ltd) 0.20 parts by mass

Further, the following components were added and polymerized at 70° C. for 4 hours to obtain a polymer, compound 8.

2, 2′-azobis (dimethyl isobutyrate) “V-601” (manufactured by FUJIFILM Wako Pure Chemical Industries, Ltd) 0.10 parts by mass

The number average molecular weight (Mn) of compound 8 was 13,500, and the polydispersity index (PDI) was 2.10. The amine value of compound 8 was 57.6 mgKOH/g.

### 2. Ink Preparation

### (1) Preparation of Ink 1

### (1.1) Preparation of Pigment Dispersion Liquid 1

The following components were placed in a thermobath of 55° C. in a polyethylene container 200 cc with a lid. Then, the mixture was heated and stirred for 30 minutes using a magnet stirrer to be dissolved. The resulting solution was cooled to room temperature.

Polymerizable compound 1: dipropylene glycol diacrylate (DPGDA) “Laromer (registered trademark) DPGDA” (manufactured by BASF). 73.50 parts by mass

Polymerization inhibitor: “Irgastab UV10” (manufactured by Ciba Japan) 0.50 parts by mass

dispersant: the aforementioned compound, 1 6.00 parts by weight

The following ingredients were added to the solution and stirred well. This mixed solution was put in a glass bottle together with 100 g zirconia beads having a size of 0.5 mm, the bottle was sealed, and the mixture was subjected to vibration dispersion with a vibration mill (Red devil 5400HC) for 2 hours. Thereafter, the zirconia beads were removed to obtain a pigment dispersion liquid 1. Note that the content of the dispersant was 30% by mass relative to the total mass of the pigment.

Pigments: Pigment Blue 15:4 20.00 parts by mass

### (2.2) Mixing of Ink Components

The following components were placed in a dissolution beaker and stirred for 30 minutes.

Polymerizable compound 1: dipropylene glycol diacrylate (DPGDA) “Laromer (registered trademark) DPGDA” (manufactured by BASF). 84.13 parts by mass

Polymerizable compound 2: triethylene glycol dimethyl acrylate (TEGMA) 1.00 parts by mass

Polymerization initiator: “DAROCURE TPO” (manufactured by Ciba Specialty Chemicals Inc) 0.50 parts by mass

To this solution, the following components were added, followed by stirring for 30 minutes.

Pigment dispersion liquid 1 (dispersant concentration: 6% by mass) 11.67 parts by mass

While this mixed liquid was heated to 80° C., the following gelling agent was added, and the mixture was further stirred for 30 minutes. Compound 6 shown below was added thereto, and the mixture was further stirred for 30 minutes. Thereafter, the mixture was filtered through a methoprene filter (nominal filtration precision 3 μm, SLS030, manufactured by Roki Techno Co., Inc) and then cooled to prepare ink 1.

Gelling agent: 2.00 parts by weight of “Kao (registered trademark) Wax T1”

Additives: compound 6 0.70 parts by mass

### (2) Preparation of Inks 2 to 23

Inks 2 to 23 were prepared in the same procedure as in the preparation of ink 1 except that the types and the contents of the pigment, the dispersant, and the additive were changed as described in Table II.

The compositions of the inks 1 to 23 are listed in Table II.

In the tables, “-” indicates that the corresponding component was not added.

Details of the pigments in the table are given below.

PB15:4: Pigment Blue 15:4

PR122: Pigment Red 122

PR202: Pigment Red 202

PV19: Pigment Violet 19

CB: carbon black “MA7” (manufactured by Mitsubishi Chemical Corporation)

Note that in Example 15, “Fastogen Super Magenta JM02” (manufactured by DIC Corporation) was used as the pigment. The pigment includes both PR122 and PV19. In Example 16, “inkjet Magenta E7B” (manufactured by Clariant) was used as the pigment. The pigment includes both PR202 and PV19.

Furthermore, the content in the table represents the content relative to the total mass of the ink. The “weight ratio A:B” represents a weight ratio of the contents of the dispersant (A) and the additives (B).

TABLE II

| | | | DISPERSANT (A) | | ADDITIVE (B) | | MASS |
|---|---|---|---|---|---|---|---|
| | INK | | | CONTENTS | | CONTENTS | RATIO |
| | No. | PIGMENT | TYPE | [% BY MASS] | TYPE | [% BY MASS] | A:B |
| EXAMPLE 1 | 1 | PB15:4 | COMPOUND 1 | 0.700 | COMPOUND 6 | 0.700 | 1:1 |
| EXAMPLE 2 | 2 | PB15:4 | COMPOUND 2 | 0.700 | COMPOUND 6 | 0.700 | 1:1 |
| EXAMPLE 3 | 3 | PB15:4 | COMPOUND 2 | 0.700 | COMPOUND 7 | 0.700 | 1:1 |
| EXAMPLE 4 | 4 | PB15:4 | COMPOUND 2 | 0.700 | COMPOUND 8 | 0.700 | 1:1 |
| EXAMPLE 5 | 5 | PB15:4 | COMPOUND 3 | 0.700 | COMPOUND 8 | 0.700 | 1:1 |
| EXAMPLE 6 | 6 | PB15:4 | COMPOUND 4 | 0.700 | COMPOUND 8 | 0.700 | 1:1 |
| EXAMPLE 7 | 7 | PB15:4 | COMPOUND 4 | 0.700 | COMPOUND 8 | 0.070 | 10:1 |
| EXAMPLE 8 | 8 | PB15:4 | COMPOUND 4 | 0.700 | COMPOUND 8 | 0.300 | 2.33:1 |
| EXAMPLE 9 | 9 | PB15:4 | COMPOUND 4 | 0.700 | COMPOUND 8 | 0.600 | 1.17:1 |
| EXAMPLE 10 | 10 | PB15:4 | COMPOUND 4 | 1.200 | COMPOUND 8 | 0.440 | 2.73:1 |
| EXAMPLE 11 | 11 | PB15:4 | COMPOUND 4 | 1.200 | COMPOUND 8 | 0.073 | 16.4:1 |
| EXAMPLE 12 | 12 | PB15:4 | COMPOUND 4 | 0.700 | COMPOUND 8 | 0.100 | 7:1 |
| EXAMPLE 13 | 13 | PB15:4 | COMPOUND 4 | 1.500 | COMPOUND 8 | 0.200 | 7.5:1 |
| EXAMPLE 14 | 14 | PB15:4 | COMPOUND 4 | 1.500 | COMPOUND 9 | 0.200 | 7.5:1 |
| EXAMPLE 15 | 15 | PR122/PV19 | COMPOUND 4 | 1.500 | COMPOUND 8 | 0.200 | 7.5:1 |
| EXAMPLE 16 | 16 | PR202/PV19 | COMPOUND 4 | 1.500 | COMPOUND 8 | 0.200 | 7.5:1 |
| EXAMPLE 17 | 17 | CB | COMPOUND 4 | 1.500 | COMPOUND 8 | 0.200 | 7.5:1 |
| COMPARATIVE | 18 | PB15:4 | COMPOUND 1 | 0.700 | — | — | — |
| EXAMPLE 1 | | | | | | | |
| COMPARATIVE | 19 | PB15:4 | — | — | COMPOUND 6 | 0.700 | — |
| EXAMPLE 2 | | | | | | | |
| COMPARATIVE | 20 | PB15:4 | COMPOUND 5 | 0.700 | COMPOUND 6 | 0.700 | 1:1 |
| EXAMPLE 3 | | | | | | | |
| COMPARATIVE | 21 | PB15:4 | COMPOUND 1 | 0.700 | COMPOUND 10 | 0.700 | 1:1 |
| EXAMPLE 4 | | | | | | | |

### 3. Evaluation

### (1) Gloss

Each of the inks obtained above was ejected from the nozzle of the inkjet head. The temperature of the ink at the time of ejection was set to 80° C. Next, the ejected ink was landed on aluminum-deposited PET sheet “SPECIALITIES-352” (manufactured by Gojo Sheet Mills Limited) and transparent PET film “AGT-ES100” (100 μm thick, manufactured by Dynic Corporation). Thereafter, the ink was cured to produce a solid image of 10 g/m². During curing, the substrate temperature was 40° C. Within one second from the landing of the ink, the ink was irradiated with ultraviolet rays using an LED lamp (wavelengths: 395 nm, illumination on substrate: 3 W/cm², manufactured by KYOCERA Corporation) such that the amount of light became 500 mJ/cm².

The produced image was visually confirmed and evaluated according to the following criteria. Note that a rating of B or higher (A and B) was accepted. Further, with respect to the criterion C, there is generally no problem in practical use, but since the present invention is extremely excellent in glossiness, the criterion B or more was evaluated as acceptable.

### (Standards)

A: Gloss is uniform and graininess is low on all substrates.

B: Aluminum-deposited PET sheet having uniform gloss and low graininess. On the other hand, in the case of the transparent PET film, the gloss is slightly uneven, but the graininess is low.

C: On all the substrates, the gloss is uneven, but the graininess is low.

D: On all substrates, the gloss is non-uniform and the roughness is noticeable.

### (2) Storage Stability

Each of the inks obtained as described above was placed in a heat-resistant glass bottle and subjected to forced degradation storage at 90° C. for 2 weeks in a state of being hermetically stoppered. Thereafter, the viscosity (mPa·s) of each ink at 80° C. before the forced degradation treatment and after the forced degradation treatment was measured with a rheometer “MCR300” (manufactured by Paar Physica). Then, the viscosity variation rate before and after the forced degradation treatment was obtained by the following equation, and the storage stability was evaluated by the following criteria. Note that there is no practical problem if the rating is B or higher (AA to B).

$$Viscosity rate = \{ ( viscosity of ink after forced degradation processing - viscosity of ink before forced degradation processing ) / viscosity of ink before forced degradation processing \} \times 100 ( \% ) . \qquad ( Formula )$$

### (Standards)

AA: The viscosity fluctuation rate is less than 5.0%.

A: The viscosity fluctuation rate is 5.0% or more and less than 10.0%.

B: The viscosity fluctuation rate is 10.0% or more and less than 15.0%.

C: The viscosity fluctuation rate is 15.0% or more.

### (3) Ejection Properties

Each of the inks obtained above was introduced into an inkjet head “HA1024 type” (manufactured by Konica Minolta, Inc.) and ejected. A nozzle check pattern was printed, and the printing result was visually observed for the presence or absence of nozzle chipping or ejection bending, and evaluated according to the following criteria. It is to be noted that there is no problem in practical use if it is B or more (A and B).

The term “nozzle deficiency” refers to a phenomenon in which ink is not ejected from the nozzle. The “ejection bending” refers to a phenomenon in which the ink is ejected from the nozzle in a bent manner.

### (Standards)

A: No occurrence of nozzle chipping or ejection bending was observed.

B: Nozzle chipping or ejection bending was observed in nozzles in the range of 1 to 9 out of the total of 1024 nozzles.

C: Nozzle chipping or injection bending was observed in 10 or more nozzles out of all 1024 nozzles.

### (4) Image Density

Each of the inks obtained above was introduced into the inkjet head “HA1024 type” (manufactured by Konica Minolta, Inc.). The ink was ejected and landed on the recording media under the conditions of printing width 100 mm×100 mm, resolution 720×720 dpi, voltage 16 V, ambient temperature 25° C., and ambient moisture 55%. Thereafter, the landed ink droplets were irradiated with ultraviolet rays having the energy of 250 mJ/cm² with an LED lamp to cure the ink droplets. Next, a solid image having a coverage rate of 100% was formed. Printing sheet “OK TOPCOAT (registered trademark)” (manufactured by Oji Paper Co., Ltd.) was used as a recording medium.

The produced image was visually observed and evaluated according to the following criteria. It is to be noted that there is no problem in practical use if it is B or more (A and B).

Note that the term “density unevenness” herein refers to color gradation that unintentionally occurs in the image. For example, in a solid image in which the density in the image is originally uniform, the color unevenness refers to local color shading unevenness or the like.

A: The image surface had almost no density unevenness and had a high density.

B: There is slight density unevenness on the image surface, and the density seems to be slightly low.

C: The image surface has density unevenness and the density is low.

The evaluation results are shown in Table III.

TABLE III

| | | EVALUATION | | | |
|---|---|---|---|---|---|
| | INK | | STORAGE | EJECTION | IMAGE |
| | No. | GLOSS | STABILITY | PROPERTIES | DENSITY |
| EXAMPLE 1 | 1 | B | B | B | B |
| EXAMPLE 2 | 2 | B | B | B | B |
| EXAMPLE 3 | 3 | B | A | B | B |
| EXAMPLE 4 | 4 | B | A | B | B |
| EXAMPLE 5 | 5 | B | A | A | B |
| EXAMPLE 6 | 6 | B | A | A | B |
| EXAMPLE 7 | 7 | B | AA | A | B |
| EXAMPLE 8 | 8 | B | AA | A | B |
| EXAMPLE 9 | 9 | B | AA | A | B |
| EXAMPLE 10 | 10 | A | AA | A | B |
| EXAMPLE 11 | 11 | A | AA | A | B |
| EXAMPLE 12 | 12 | A | AA | A | B |
| EXAMPLE 13 | 13 | A | AA | A | B |
| EXAMPLE 14 | 14 | A | AA | A | B |
| EXAMPLE 15 | 15 | A | AA | A | A |
| EXAMPLE 16 | 16 | A | AA | A | A |
| EXAMPLE 17 | 17 | A | AA | A | A |
| COMPARATIVE | 18 | C | B | B | B |
| EXAMPLE 1 | | | | | |
| COMPARATIVE | 19 | C | B | B | B |
| EXAMPLE 2 | | | | | |
| COMPARATIVE | 20 | D | C | B | C |
| EXAMPLE 3 | | | | | |
| COMPARATIVE | 21 | C | C | C | C |
| EXAMPLE 4 | | | | | |

It is understood from Examples and Comparative Examples that the glossiness is improved in the image formed using the ink of the present invention.

It is understood from Examples 2 to 4, 13, and 14 that when the compound having a pyridine structure is an acrylic polymer compound, the storage stability of the ink is improved.

It can be seen from Examples 1, 2, 5, and 6 that when the compound having a hydroxy fatty acid-derived structure and a basic functional group has a hydroxystearic acid-derived structure and an amine value is within the range of 10 to 20 mgKOH/g, the storage stabilities of the inks are improved.

It is understood from Examples 6, 7, 9, and 12 that when the content of the compound having a pyridine structure is in a range of 0.1 to 0.6% by mass relative to the total mass of the active energy ray curable inkjet ink, the glossiness and the ejection property are improved.

It is found from Examples 6, 10, and 11 that when the mass ratio of the compound having a structure derived from a hydroxy fatty acid and a basic functional group to the compound having a pyridine structure is in the range of 2.73:1 to 16.4:1, the glossiness and the ejection property are improved.

The following can be understood from Examples 13 and 15 to 17. The pigment is carbon black or a magenta pigment, and the magenta pigment contains any of C. I. Pigment Violet 19, C. I. Pigment Red 122, and C. I. Pigment Red 202. Thus, the image density is improved.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-122941, filed on Jul. 28, 2023, including description, claims, drawings and abstract is incorporated herein by reference.

1. An active energy ray curable inkjet ink comprising:
a pigment, a dispersant, a gelling agent, and an additive,
wherein,
a compound having a structure derived from a hydroxy fatty acid and a basic functional group is contained as the dispersant, and
a compound having a pyridine structure is contained as the additive.

2. The active energy ray curable inkjet ink according to claim 1, wherein the compound having the pyridine structure is an acrylic polymer compound.

3. The active energy ray curable inkjet ink according to claim 1, wherein the compound having the structure derived from the hydroxy fatty acid and the basic functional group has a structure derived from hydroxystearic acid and has an amine value in a range of 10 to 20 mgKOH/g.

4. The active energy ray curable inkjet ink according to claim 1, wherein a content of the compound having the pyridine structure is within a range of 0.1 to 0.6% by mass relative to a total mass of the active energy ray curable inkjet ink.

5. The active energy ray curable inkjet ink according to claim 1, wherein a mass ratio of the compound having the structure derived from the hydroxy fatty acid and the basic functional group to the compound having the pyridine structure is within a range of 2.73:1 to 16.4:1.

6. The active energy ray curable inkjet ink according to claim 1,
wherein,
the pigment is carbon black or a magenta pigment, and
the magenta pigment contains any of C. I. Pigment Violet 19, C. I. Pigment Red 122, and C. I. Pigment Red 202.

7. A method for producing an active energy ray curable inkjet ink to produce the active energy ray curable inkjet ink according to claim 1, the method comprising:
preparing a pigment dispersion liquid containing the pigment and the dispersant; and
preparing the active energy ray curable inkjet ink containing the pigment dispersion liquid, the gelling agent, and the additive.

8. An inkjet recording method for recording by causing ejected ink to land on a recording medium, the method comprising:
recording using the active energy ray curable inkjet ink according to claim 1,
wherein an ejection temperature of the ink is within a range of 40 to 120° C., and
a temperature of the recording medium is 60° C. or lower.

9. An inkjet recording system that performs recording by causing ejected ink to land on a recording medium, the inkjet recording system comprising;
the active energy ray curable inkjet ink according to claim 1.
